(19) United States
(12) Patent Application Publication
(10) Pub. No.: US 2026/0167571 A1
(43) Pub. Date: Jun. 18, 2026

(54) DELIVERY METHODS AND PROCESSES FOR ENCAPSULATING WASTE IN SITU

(71) Applicant: GO TEAM CCR, LLC, Wilmington, DE (US)

(72) Inventors: Francis Norbert Hector, JR., Wilmington, DE (US); Andrew Thomas Knotts, Chadds Ford, PA (US)

(21) Appl. No.: 19/535,717

(22) Filed: Feb. 10, 2026

Related U.S. Application Data
(63) Continuation of application No. PCT/US2025/051566, filed on Oct. 17, 2025.
(60) Provisional application No. 63/709,249, filed on Oct. 18, 2024.

(51) Int. Cl. C04B 28/02

(52) U.S. Cl. CPC C04B 28/02

(57) ABSTRACT

A system for depositing material includes: an elongate rotatable casing for placement into a substrate material; a non-rotatable conveyance pipe having a segment within the casing; a rotary union in the casing coupled to the segment; a rotatable conveyance pipe in the casing below the rotary union and coupled to the segment via the rotary union; an outlet pipe having a first end flexibly coupled to the rotatable conveyance pipe; a chute hingedly connected to and rotatable with the casing and configured to open and close. The casing is rotated as material is pumped into the conveyance pipe or a section of rotatable conveyance pipe attached to the segment by a pipe swivel joint. The material flows from the conveyance pipe and into the rotatable conveyance pipe through the rotary union, from the conveyance pipe into the outlet pipe, and from the outlet pipe onto or into the substrate material.

### CROSS-REFERENCE TO RELATED APPLICATION

This application is a continuation of and claims the benefit of priority of international patent application no. PCT/US2025/051566, titled “DELIVERY METHODS AND PROCESSES FOR ENCAPSULATING WASTE IN SITU,” filed on Oct. 17, 2025, which is incorporated herein in its entirety by this reference. The PCT/US2025/051566 application claims the benefit of priority of U.S. provisional patent application No. 63/709,249, titled “DELIVERY METHODS AND PROCESSES FOR ENCAPSULATING WASTE IN SITU,” filed on Oct. 18, 2024, which is incorporated herein in its entirety by this reference.

### TECHNICAL FIELD

The present disclosure relates to material encapsulation and the means and methods for placement of materials for any reason, for depositing any material below grade, and for example for the creation of a groundwater barrier. More particularly, the present disclosure relates to in-situ encapsulation of material in damp, liquidous, and submerged form.

### BACKGROUND

A material known as coal combustion ash or “coal combustion residual” (“CCR”). CCR is finely comminuted particles of material that remain after coal has been burned to provide the immense quantities of heat required to operate high-pressure steam boilers in coal fired electric power plants operated by electric power utilities such as the Tennessee Valley Authority, Duke Energy, and others. CCR accumulates in vast quantities, and storing the material requires significant expense combined with environmental risk. In recent years, regulatory authorities have taken an increasingly negative view of the manner in which CCR's are stored and have enacted regulations that will require that CCR's be handled in a manner different from past practice.

Each year in the United States over one hundred million tons of CCR is generated and must be beneficially used or disposed of in some manner. Approximately half of the ash is now disposed of by on-site landfilling. However, some small part of the ash is used as a component in building materials mainly cast-in-place concrete or concrete pavement roadways. (See American Coal Ash Association (ACAA) Coal Combustion Product (CCP) Production & Use Survey Report, 2013 and 2015).

Improvements in in-situ stabilization and/or encapsulation of the above-mentioned and other materials are needed.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

It is one object of the present invention to provide a novel delivery and process method to encapsulate waste in situ. The specific beneficial use of the CCR is the construction of a pumped storage hydro (PSH) facility using CCR as a major building component. The invention uses in situ encapsulation of the waste material to meet the requirements of the federal CCR rule that was promulgated in 2015, and which has had several court rulings which has clarified what is allowed and not allowed for the proper remediation of CCR. It is another object of this invention on novel apparatuses to perform in situ encapsulation.

A potential beneficial use of CCR is in the construction of a PSH. The novel inventions disclosed could be used in any situation that requires conveying large quantities of material below grade. Groundwater cutoff walls, horizontal and vertical groundwater barriers, CCR stabilization & pollution remediation are potential subjects focused on herein as examples. The inventions also include novel methods on encapsulation using MICP and enzyme-induced carbonate precipitation EICP.

According to at least one embodiment, a method for constructing an encapsulation barrier includes: positioning a tremie pipe over a surface of a substrate material at first pile point; attaching a capping element to a lower end of the tremie pipe; lowering the capping element and a portion of the tremie pipe into the substrate material at the first pile point; applying an encapsulation material into an upper end of the tremie pipe until an upper surface of the encapsulation material reaches a particular level relative to the surface of the substrate material; raising the tremie pipe while maintaining the upper surface of the encapsulation material at the particular level relative to the surface of the substrate material; inserting a mixing tool into the tremie pipe, the mixing tool pushing the encapsulation mixture downward within the tremie pipe; and applying an additional volume of encapsulation material into the tremie pipe to form an encapsulation barrier.

The method may further include leaving the capping element within the substrate material below the encapsulation mixture while raising the tremie pipe.

The capping element may be, as non-limiting examples, a sacrificial shoe, a sacrificial plate, or a sacrificial drill tip.

The capping element may have a hinged bottom.

Lowering the capping element and a portion of the tremie pipe may include rotating the tremie pipe.

The tremie pipe may include external threads for drilling/auger action.

The substrate material may include at least one of air, oil, and resins.

The encapsulation material may include at least one of coal combustion reside (CCR) and oil.

The encapsulation material may include cement.

The above summary is to be understood as cumulative and inclusive. The above and below described features are to be understood as combined in whole or in part in various embodiments whether expressly described herein or implied by at least this reference. For brevity, not all features are expressly described and illustrated as combined with all other features. No combination of features shall be deemed unsupported for merely not appearing expressly in the drawings and descriptions.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1 depicts use of a bio-geopolymer as the in situ encapsulation material, according to one embodiment.

FIG. 2 depicts the known prior art process of in situ encapsulation using jet grouting, according to one embodiment.

FIG. 3 depicts a discrete zone to be encapsulated for the VGB, according to one known prior art embodiment.

FIG. 4 depicts a known prior art soil mixing tool located at the bottom of a rotor with encapsulation materials and biding agents injected via the ports, according to one embodiment.

FIG. 5 depicts other prior art known types of below surface grade mixing encapsulation equipment, according to one embodiment.

FIG. 6 depicts other known prior art types of below surface grade mixing encapsulation equipment, according to one embodiment.

FIG. 7A depicts the process of constructing a displacement pile as it is used in the industry, according to one embodiment.

FIG. 7B shows a lower portion of the tremie pipe with auger and capping element shown as a sacrificial plate.

FIG. 8A depicts a capping element as a sacrificial plate at the bottom of the drill screw tremie pipe used to keep other CCR material from entering the drill screw tremie pipe, according to one embodiment.

FIG. 8B depicts several views of a sacrificial plate;

FIG. 8C shows a lower portion of helical drill tool and capping element shown as a sacrificial drill tip.

FIG. 8D shows the sacrificial drill tip left in-situ.

FIG. 8E shows conical points that can be used as another type of sacrificial capping element.

FIG. 9 depicts a known type of equipment used for displacement pile installation, according to one embodiment.

FIG. 10A depicts a capping element as a first hinged bottom plate, in an open condition, which can be used in lieu of the sacrifical plate as shown in FIG. 8A.

FIG. 10B depicts a second hinged bottom plate in a closed condition.

FIG. 11A depicts a piece of equipment with a hollow-core stem and an auger for placing encapsulation material directly into the Vertical Groundwater Barrier (“VGB”) encapsulation zone.

FIG. 11B depicts the type of incline of the encapsulation material delivery system which could be employed, according to one embodiment.

FIG. 12A depicts encapsulation material pretreated with microbes and placed inside a displacement pile surrounded by CCR prior to the start of the mixing using rotating mixing attachment, according to one embodiment.

FIG. 12B shows the encapsulation material of FIG. 12A, with microbes and nutrients, mixed in and spread out.

FIG. 13 depicts custom designed and fabricated, barge mounted mixing equipment, according to one embodiment.

FIG. 14 depicts another view of the barge mounted mixing equipment shown in FIG. 13 according to one embodiment.

FIG. 15 is a perspective view of an inventive sub-surface encapsulation system, according to at least one embodiment.

FIG. 16 is a cross section view of the system of FIG. 15.

FIG. 17 is a rotary drive of the prior art.

FIG. 18 is a perspective view of deep foundation equipment of the prior art, including the rotary drive of FIG. 17.

FIG. 19 shows the rotary drive of FIG. 17 used with a casing that will have an open top 7 to allow for a concrete pipe to be placed down through the casing.

FIG. 20 shows a portion of an apparatus with a concrete delivery system having a concrete swivel and gooseneck.

FIG. 21 shows the apparatus of FIG. 20 with the concrete delivery system.

FIG. 22 shows a known closed concrete swivel system and with rotary head.

FIG. 23 shows a known type of extraction device, with cables that travel down the front and the back of the mast of deep foundation equipment to hydraulic winches.

FIG. 24 is a view of deep foundation equipment's mast shown in FIG. 23.

FIG. 25 shows schematic cross section cut of a CCR impoundment with different moisture contents for the below grade CCR.

FIG. 26 illustrates a ground-water barrier (GWB) constructed in-situ, according to at least one inventive embodiment.

FIG. 27 depicts an aerial view of placing a GWB prior to the infill sections of FIG. 26 being placed.

FIG. 28 shows a core barrel metal form attached to the casing of the inventive sub-surface encapsulation system FIG. 15.

FIG. 29 shows a section cut of the equipment of FIG. 28.

FIG. 30 shows a core barrel metal form attached to the casing of the inventive sub-surface encapsulation system FIG. 15, with openings through the wall of the core barrel metal form as a non-limiting example arrangement.

FIG. 31 shows a top view of a multi-passage rotary union, located inside a casing.

FIG. 32 shows a vertical cross section of the apparatus of FIG. 31.

FIG. 33 shows a bottom view of the apparatus of FIG. 31.

FIG. 34 illustrates an upper portion inventive sub-surface encapsulation system with a rotary union for hydraulic oil and concrete, according to at least one embodiment.

FIG. 35 illustrates the inventive sub-surface encapsulation system of FIG. 34 with a core barrel metal form attached to the casing and showing braces that travel along rail guides as chutes open and close.

FIG. 36 shows a detail of the hydraulic workings of the system of FIGS. 34 and 35.

FIG. 37A is a perspective view of the system and core barrel metal form of FIG. 35.

FIG. 37B is a perspective view of the system and core barrel metal form of FIG. 35 interior spiral ramps.

FIG. 38 shows the equipment of FIGS. 35-37 when the concrete chutes are in closed positions and the concrete pipes are in the interior of the casing.

FIG. 39 is a vertical cross section view of a casing for and inventive sub-surface encapsulation system with inventive material delivery components according to at least one embodiment.

FIG. 40 is a detailed enlargement of the receiving supply container, the steel plate that divides the casing into halves, and the hydraulic motors of the system of FIG. 39, according to at least one embodiment.

FIG. 41 shows an inventive sub-surface encapsulation system, according to at least one embodiment, in which concrete piping is spread out by pushing a rigid inner concrete pipe down relative to the casing.

FIG. 42 shows the system of FIG. 41 with the concrete outlets retracted and doors closed.

### DETAILED DESCRIPTIONS

These descriptions, of which the drawings are a part, are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Any materials described are provided as non-limiting examples except where their inclusion is positively and unambiguously asserted. Once materials and arrangements are described herein with reference to any structures and elements thereof, for example in the drawings, such descriptions apply as well to any further same or similar structures and elements that may appear in other drawings.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

Unless defined otherwise, technical and scientific terms used herein have the same meaning as commonly understood to one of ordinary skill in the art to which the presently disclosed subject matter pertains.

Inventive products and methods for production thereof need not literally ever be implemented as expressly illustrated in the drawings, in which rectangular, linear, and/or other simple geometric graphical representations are shown. The drawings are to be taken as conceptual, representative, exemplary, and non-limiting. Each drawing nonetheless does literally represent at least an embodiment of its illustrated subject matter.

CCR may include fly ash, bottom ash, boiler slag, flue gas desulfurized gypsum (FGD Gypsum) and coal combustion products. The apparatuses shown in this disclosure can be used on other types of sites, in addition to CCR sites, that require encapsulation and/or stabilization.

The management of CCR is regulated at both the federal and the state level. The Federal CCR Rule, 80 Fed. Reg. § 21302 (Apr. 17, 2015) and the Direct Final Rule (Oct. 4, 2016), regulate coal ash as a solid waste and not as a hazardous waste. The Rule sets minimum standards for disposal and/or disposition of coal ash. Other state and federal regulations continue to apply to CCR disposal. The Federal CCR Rule includes detailed standards for the design and location of CCR landfills and impoundments, groundwater monitoring, remediation, structural integrity and final closure of landfills and impoundments.

Embodiments of methods and apparatuses can be used for purposes that at not limited to those defined “beneficial.” The Federal CCR Rule does not regulate practices that meet the definition of a “beneficial” use of CCR, which must meet all of the following conditions, as found in 80 Fed. Reg. at § 21349. (1) the CCR must provide a functional benefit;
(2) the CCR must substitute for the use of a virgin material, conserving natural resources that would otherwise need to be obtained through practices such as extraction;
(3) the use of CCR must meet relevant product specifications, regulatory standards or design standards when available and when such standards are not available, CCR are not used in excess quantities; and
(4) when un-encapsulated use of CCR involves placement on the land of 12,400 tons or more in non-roadway applications, the user must demonstrate and keep records and provide such documentation upon request, that environmental releases to groundwater, surface water, soil and air are comparable to or lower than those from analogous products made without CCR, or that environmental releases to groundwater, surface water, soil and air will be at or below relevant regulatory and health-based benchmarks for human and ecological receptors during use.
   EPA's final CCR management rule
   (https://www.regulations.gov/doucment?D=EPA-HQ-RCRA-2009-0640-11970), and EPA's direct final CCR management rule https://www.epa.gov/coalash/coal-ash-rule. Worldwide web links are provided for easy reference.

Any use that fails to comply with each of the above criteria is considered “disposal” of CCR and is subject to all disposal requirements in the Federal CCR Rule.

In response to a 2018 ruling by the United States Court of Appeals for the District of Columbia Circuit, the Environmental Protection Agency (EPA) classified unlined coal residual units, which were interpreted as being units that do not have composite liner preventing leakage into the soil as open dumps. As a result, such locations were required to initiate closure by Apr. 11, 2021. See Hazardous and Solid Waste Management System: Disposal of Coal Combustion Residuals from Electric Utilities; A Holistic Approach to Closure Part A: Deadline to Initiate Closure, 85 Fed. Reg. 53516, 53517 (Aug. 28, 2020). Electrical Utilities petitioned to leave CCR in place, put a synthetic liner over the CCR and leave the CCR in contact with ground water. The EPA provided an exemption to the requirement to close by Apr. 11, 2021 if the owner/operator could establish (1) that “[n]o alternative disposal capacity is available on or off-site” of the facility, and (2) that the owner or operator remains in compliance with all of the other requirements of the coal residuals regulations. 40 C.F.R. § 257.103 (a) (1) (i), (iii). Those facilities that received an extension, however, were not allowed to operate beyond Oct. 15, 2024. Id. § 257.103 (f) (1) (vi), (vii). Despite applications for an extension, some facilities were denied an extension. In some cases, one of the reasons the extension was not granted was because the extension applications did not discuss any “engineering measures taken to ensure that the groundwater had been removed from the unit prior to the start of installing the final cover system, as required by 40 C.F.R. § 257.102 (d) (2) (i).” Given the potential for groundwater to infiltrate the coal residual unit and for coal residuals to dissolve in the water and migrate out of the unit, the EPA determined that the requirement to demonstrate how those units had been closed in a manner that would “[c]ontrol, minimize or eliminate, to the maximum extent feasible, post-closure infiltration of liquids into the waste and releases of [coal residuals], leachate, or contaminated run-off to the ground or surface waters or to the atmosphere” had not been satisfied. 40C.F.R. § 257.102 (d) (1) (i).

On Jun. 28, 2024, the UNITED STATES COURT OF APPEALS for the District of Columbia issued a court ruling in Electric Energy, Inc. v. EPA, No. 22-1056 (D.C. Cir. 2024) directly concerning the federal CCR rule. The court reviewed rules under which the “EPA may require [operators] to implement engineering measures designed to interrupt any contact between the groundwater and coal residuals in the relevant unit” and that a 2015 Rule requires unit operators closing surface impoundments with waste in place to eliminate “free liquids”-“liquids that readily separate from the solid portion of a waste under ambient temperature and pressure,” 40 C.F.R. § 257.53—from the impoundment before installing the final cover system. Id. § 257.102 (d) (2) (i). Specifically, the 2015 Rule, was interpreted such that “operators cannot close their surface impoundments with groundwater leaching in and out of the unit and mixing with the coal residuals. EPA's proposed action contemplates enforcing those closure standards by requiring the unit's operator to discuss ‘the engineering measures taken’ before installation of the cover system ‘to ensure that the groundwater had been removed from the unit,’ and to describe the steps taken to control water and waste flow in and out of the surface impoundment.” Electric Energy, Inc. v. EPA at 15. The court determined that the mandate in section 257.102 (d) (1) that units “control, minimize or eliminate post-closure infiltration of liquids into the waste” appears in a set of requirements applicable to the closure of the coal residual “unit” as a whole. 40 C.F.R. § 257.102 (d) (1) (i). Further, the court held that the EPA did not amend the 2015 Rule when it asserted that ‘a self-supporting concrete settling tank system is a coal residual surface impoundment within the meaning of 40 C.F.R. § 257.53. Section 257.53 defines a surface impoundment as “a natural topographic depression, man-made excavation, or diked area, which is designed to hold an accumulation of [coal residuals] and liquids.’ 40 C.F.R. § 257.53” Electric Energy, Inc. v. EPA at 18. Further, the court held that unit operators could not close surface impoundments with coal residuals saturated in groundwater. Id. at 23. The EPA “considers groundwater to be a liquid under the existing regulation” and that “a closed, unlined impoundment, where the [coal residual] remains in groundwater several feet deep” did not meet the requirements of § 257.102 (d). Id. at 25. As a result of these holdings, the unit's operator will be required to discuss the engineering measures” taken before installation of a cover system in order to ensure that the groundwater had been removed from the unit. Further, the unit's operator must describe the steps taken to control water and waste flow in and out of the surface impoundment. By taking these steps to demonstrate the engineering measures taken to ensure groundwater had been removed from the unit and steps to control water and waste flow into and out of the surface impoundment, this would enable the CCR ponds to be closed and the CCR to be left in place while in contact with ground water.

In order to achieve suitable encapsulation of CCRs and other deleterious materials, the mix design and applications for this invention follows the required US EPA requirements. Specifically encapsulated beneficial uses are those where the material is bound in a solid matrix that minimizes mobilization of heavy metals and other deleterious constituents into the surrounding environment.

There are two categories of encapsulation: (1) dewater, excavate, encapsulate, place the encapsulated CCR into the structure and then compact the CCR material, or (2) in situ encapsulation. The dewatering and complete excavation process is one option that is being explored, but it is not the preferred option due in part to the construction time being increased by multiple years and the cost to treat the water from the dewatering process becoming a major cost component.

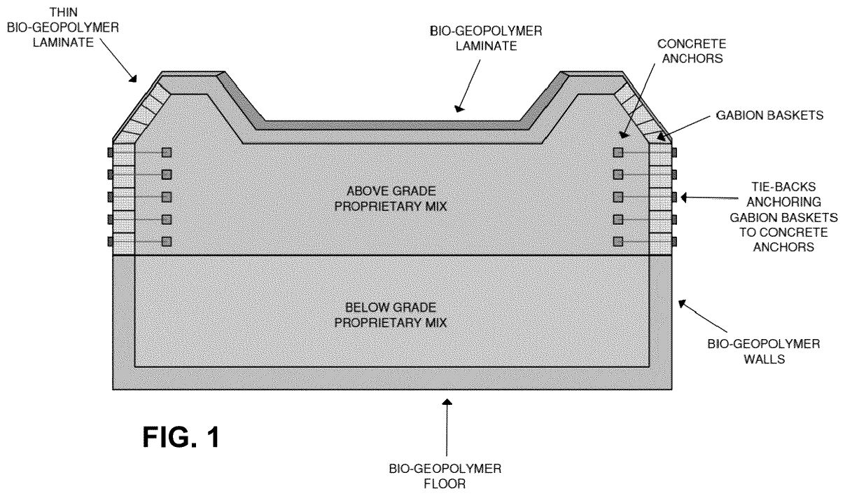

Known prior art in situ encapsulation processes have been studied but have a major hurdle in that none can be performed in a timely fashion and within the allowed timeframe of the construction schedule. Before the known methods of encapsulation are discussed, it will be helpful to schematically show different parts of the pumped storage hydro (PSH) CCR beneficial use structure. The method described in this application can be used for both the floor, which is known in the industry as the vertical groundwater barrier (VGB), and the below grade walls, known in the industry as the horizontal groundwater barrier (HGB), of the beneficial use structure shown in FIG. 1.

FIG. 1 shows using a bio-geopolymer as the in situ encapsulation material, for the VGB and HGB, but the in situ encapsulation process described in this application can be used on many different types of materials including but not limited to cementitious, bentonite, boiler slag, lime, polymers, bio-geo polymer, geopolymers, gypsum, ground gypsum, calcined materials, fly ash, bottom ash, flue gas desulfurization (FGD) gypsum, oils, resins, asphalt, tar, concrete, waterproof concrete, flowable fill and microbially induced calcite precipitation (MICP) materials, and enzyme induced calcite precipitation (EICP) materials amongst others. The VGB construction areas may also require prefilling with solids that can displace and/or absorb water before the final stage of encapsulation is commenced. Materials and products that are known to absorb water can also be used. Some of the invention embodiments in this application perform the function of prefilling VGB and HGB areas.

The novel application process to timely and efficiently perform the in-situ encapsulation process shall be described herein.

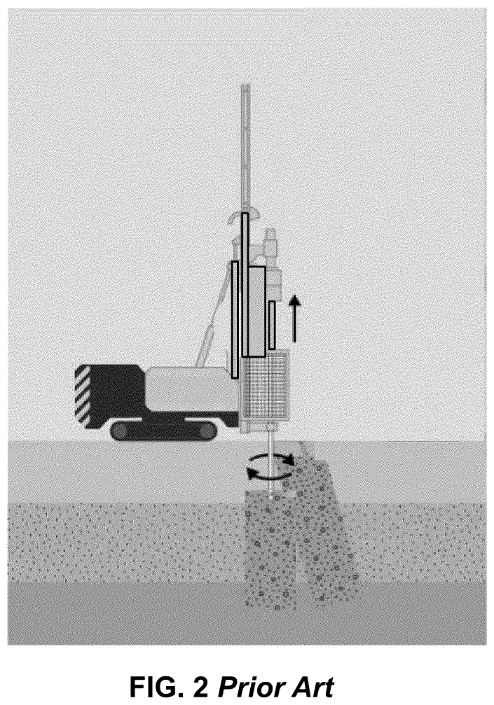

Referencing the floor shown in FIG. 1, which is also known in the industry as the vertical groundwater barrier (VGB), all of the geotechnical firms that have been consulted have stated that the preferred method of in situ encapsulation for the VGB is to use a method known in the industry as “jet grouting”. Jet grouting constructs cemented soil from high-velocity fluid jets, which creates in situ geometries of soilcrete (grouted soil). The cemented soil of jet grouting incorporates varying geometries. Jet grouting utilizes a grouting monitor attached to the end of a drill stem. The jets used for jet grouting are initiated from ports in the monitor and the jets erode/mix grout with in-situ soil as the drill stem and monitor are raised and rotated. FIG. 2 graphically shows the process of in situ encapsulation using jet grouting. Jet Grouting requires the use of very high-pressure air that may cause structural instability in CCR ponds. The apparatuses inventions which use pressurized air shown in detail in this application use a much lower air pressure than as required for Jet Grouting and/or soil mixing.

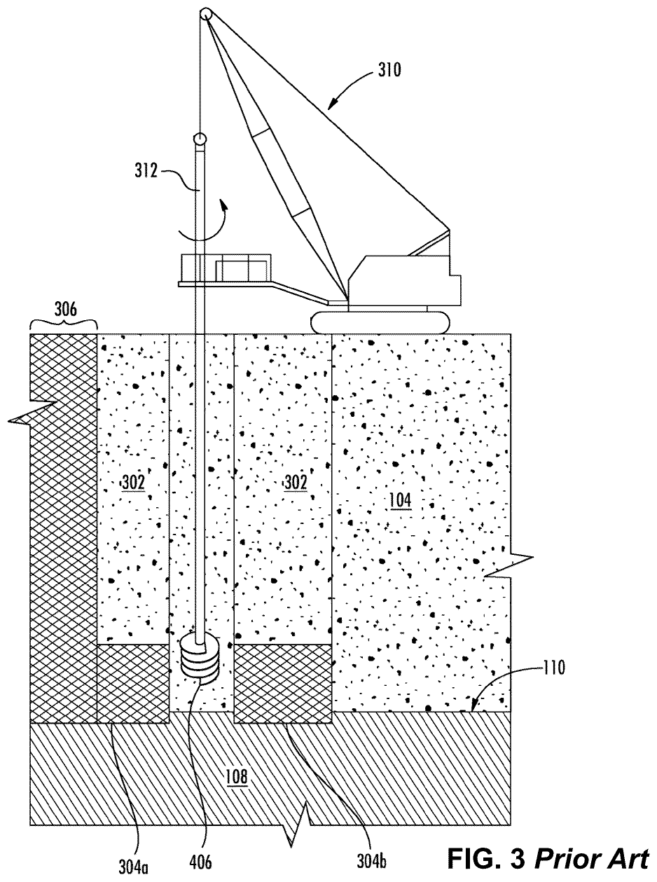

FIG. 3 depicts a discrete zone to be encapsulated for the VGB which will create a groundwater barrier. The process can be used for both full depth encapsulation and discrete zone encapsulation. The injection ports at the bottom of the rotor of the equipment used to carry the encapsulation materials to the below grade elevation, are normally less than inch in size, therefore making the time to deliver large quantity of materials to the encapsulation zone a very time consuming process.

In FIG. 3, a crane 310 is used to suspend and maneuver the rotary drive into the ground at specific locations. A Kelly bar (312) is the main tool to place a cylindrical device (406) that is inserted into the soil. As described in U.S. Patent Application Publication No. US20160237639A1, FIG. 3 is a cross-sectional view of waste material in an impoundment undergoing conventional fully penetrating and discrete in situ solidification/stabilization (ISS) during waste remediation. ISS equipment 310 and 312 are shown applying ISS techniques through waste material 104 above the bottom 110 of the impoundment. The fully penetrating ISS technique is applied to mix engineered cementitious grout in situ from the surface to a desired depth, for example to the underlying native material 108, to create a vertical barrier 306. The discrete ISS technique advances augers through the overlying waste material 302 and mixes and applies engineered cementitious grout at a desired discrete interval 304a, 304b only to construct a horizontal barrier to stop the vertical movement of water. This leaves the overlying waste material 302 in its original state. FIG. 3 also shows the ISS equipment 310 and 312 in the process of constructing a horizontal barrier 304. The drilling Kelly bar 312 and penetrating large diameter auger 406 have been advanced to the targeted elevation and are prepared to mix/apply engineered cementitious grout in situ at the specified target zone to construct a low permeability horizontal barrier.

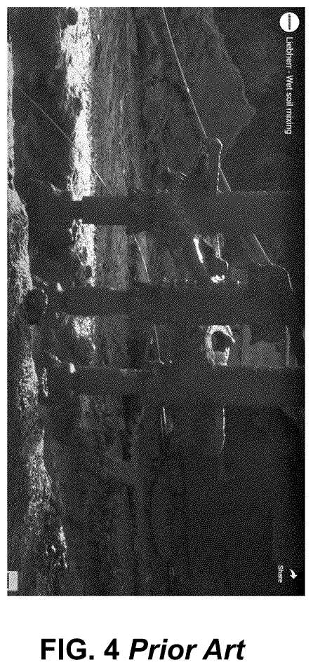

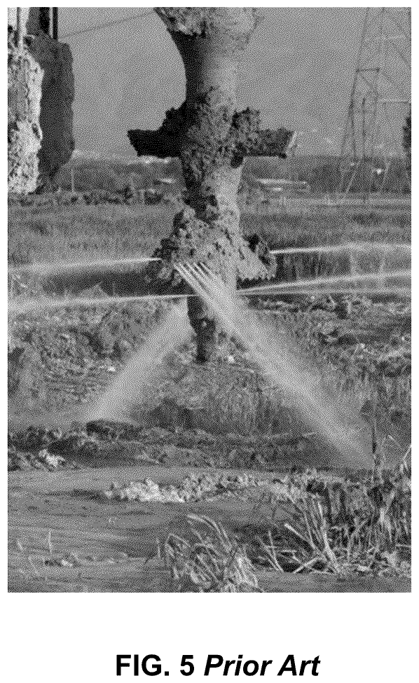

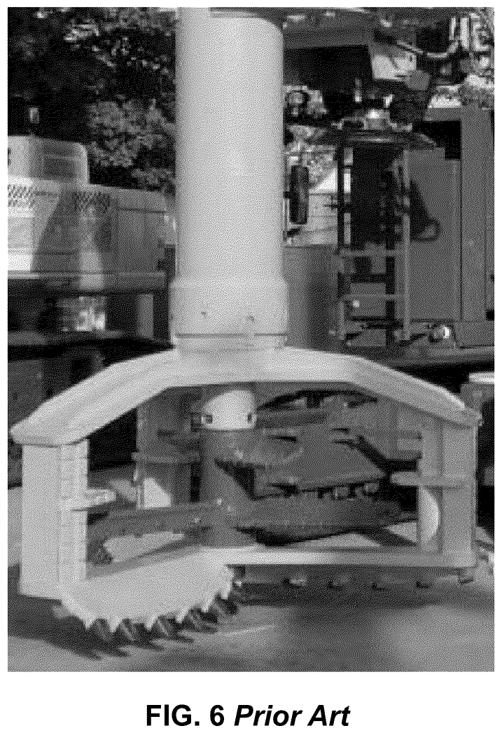

FIG. 4 shows one type of soil mixing tool of the prior art which is located at the bottom of a rotor and encapsulation materials and biding agents are injected via the ports. There are several different types of soil mixing encapsulation tools, all with injection ports sized less than 1 inch. FIG. 5 and FIG. 6 are shown for reference of other known types of below surface grade mixing encapsulation equipment.

The inability for the known encapsulation methods to timely deliver materials to the encapsulation zone is the reason for the invented processes and apparatuses in this application. Many of the discrete encapsulation zones are in high moisture content areas which increases the requirement for additional materials, which may or may not be solid, to be transported to the encapsulation zone to solidify and encapsulate these areas. A proposed CCR PSH project site has a proposed encapsulation zone of three (3) feet in depth for the VGB using encapsulation material. In that example, approximately 60% of the encapsulation zone consists of the materials and minerals that are existing below grade, and 40% of the VGB will be materials that are above grades and conveyed downward to the VGB encapsulation zone. 1 acre=43,560 square feet*3 feet in depth=130,680 cubic feet=4,840 cubic yards 4,840 cubic yards*40 percent conveyed from above grade equals=1,936 cubic yards per acre which needs to be conveyed from above grade to the encapsulation zone below grade. Not all examples fall within these parameters.

For a mental picture of this quantity, 1,936 cubic yards, the amount of material per acre that would be conveyed to the below grade encapsulation zone, would be more than 100 tandem wheeled dump trucks that are commonly seen on the highways hauling material. It is evident why the time it takes to move this material through small injection ports in prior art is such a time-consuming process.

A preferred embodiment of the invention is to use a deep foundation application method, which is known as a displacement pile, but in lieu of filing the pile with concrete, the displacement pile is filled with part of the materials that comprise the mix formulation of the encapsulation materials that are required in the below grade encapsulation zone which produces a groundwater barrier. In reference to the bio-geopolymer option, this would consist of a proprietary mix of CCR and oils, which is placed in the displacement pile.

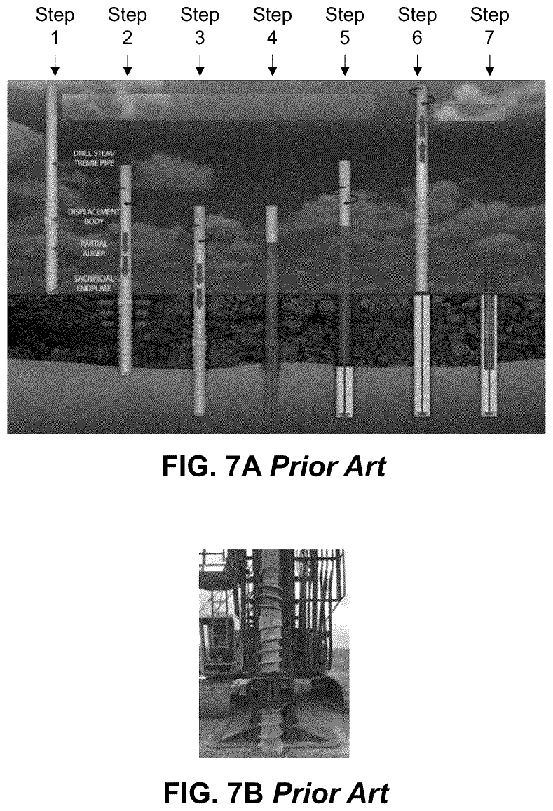

FIG. 7A shows a prior art process of constructing a displacement pile as it is used in the industry. FIG. 7B is an image of the tool referenced in descriptions below of FIG. 7A. Steps numbered as 1-7 in FIG. 7A can be described as:
Step 1: Position tooling over the pile point and attach sacrificial endplate.
Step 2: Advance tooling by rotating clockwise and applying crowd force. Note that all material is displaced laterally. Pile installation does not create spoils or vibration.
Step 3: Penetrate into bearing layer as specified.
Step 4: Place full length center reinforcing bar into tremie, them pump tremie full of concrete to a level above the ground.
Step 5: Withdraw tooling using counter-clockwise rotation while maintaining the concrete level within the tremie. Not that the sacrificial endplate remains at the pile tip.
Step 6: Upon withdrawal of the tooling, clean pile head of debris.
Step 7: Insert additional reinforcing steel as required to satisfy the specified pile load of requirements.

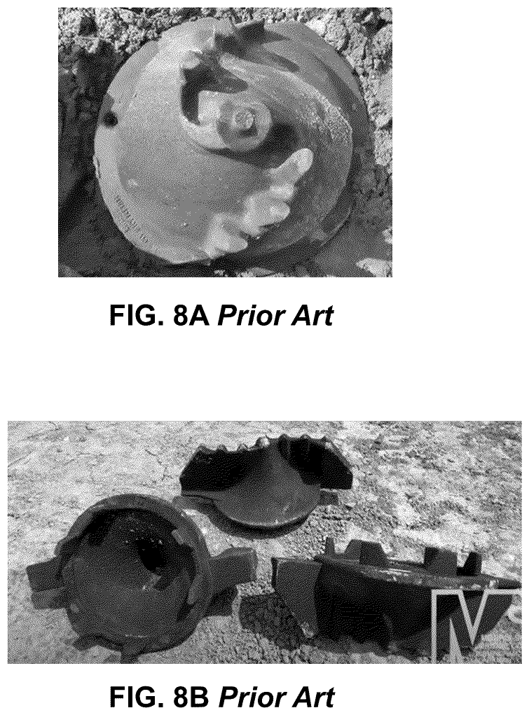

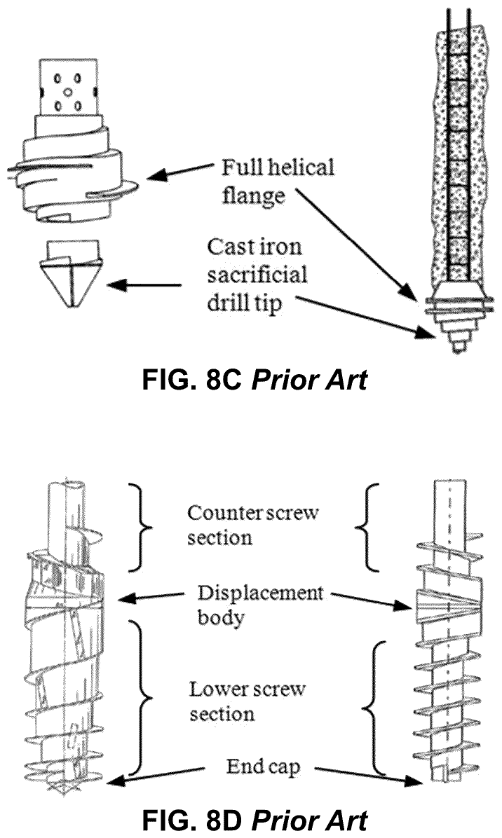

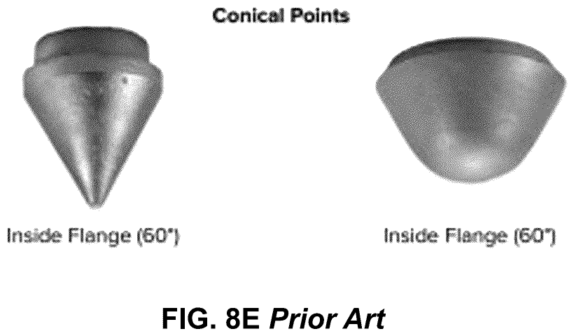

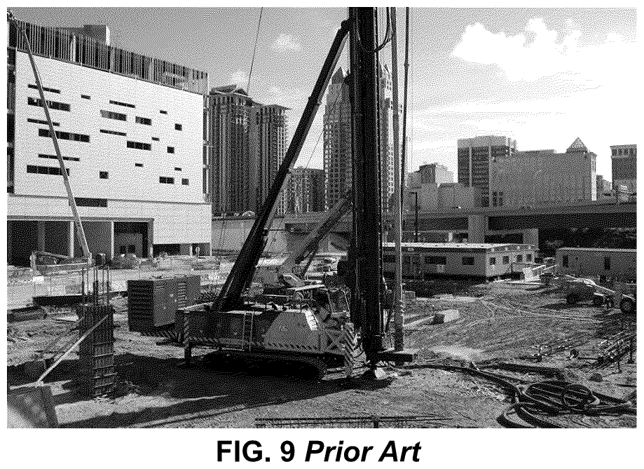

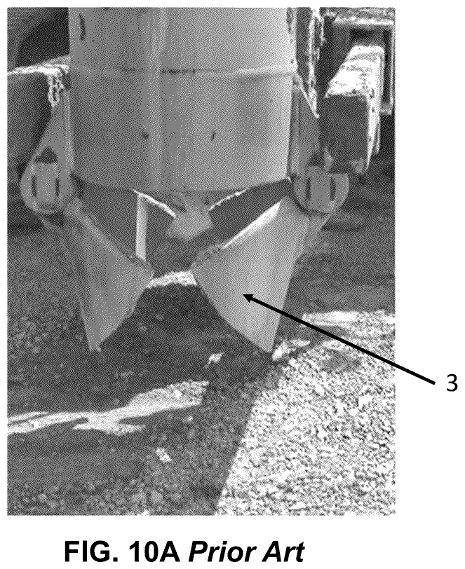

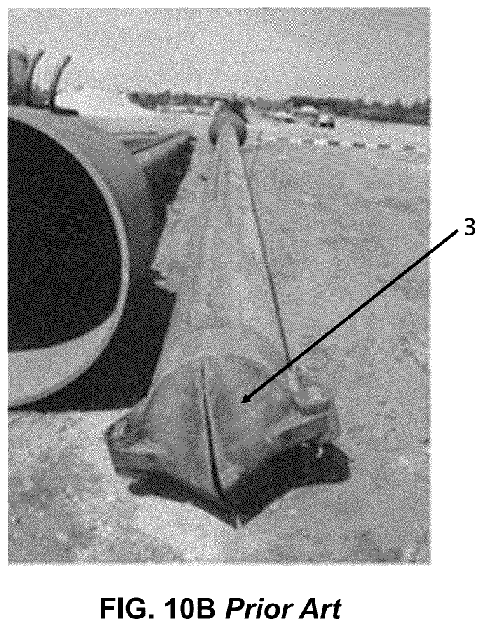

With reference to FIG. 7A, the disclosed process of this invention would incorporate steps 1, 2, and 3; however steps 4, 5, 6 and 7 would be different. No reinforcing steel would be placed in the drill screw tremie pipe, but the encapsulation mixture (which may or may not consist in whole or in part of concrete) would be placed in the tremie pipe. The sacrificial plate at the bottom of the drill screw tremie pipe as depicted in FIGS. 8A and 8B may still be used to keep other CCR material from entering the drill screw tremie pipe during steps 1, 2 and 3 as show in FIG. 7A. FIG. 9 shows a picture of the type of equipment used for displacement pile installation. In lieu of a sacrificial plate as shown in FIG. 7B, a hinged bottom can be used as shown in FIGS. 10A-10B.

Below grade geological conditions may require the encapsulation material to be dispersed additionally into the encapsulation zone, as the tremie pipe is rotated out, leaving the sacrificial plate in place, and the extraction of the tremie pipe can be paused to apply several known different types of force (kinetic, gravity, vibratory, air, etc.,) to the encapsulation material in the tremie pipe to spread the encapsulation material near the bottom of the tremie pipe further into the encapsulation zone. A heating element may be added to help with certain materials (tar, asphalt, MICP, EICP). A method similar to a Franki pile method (also known as pressure-injected footings (PIFS)) could be used. PIFS are high-capacity, cast-in-place elements constructed using a drop weight and casing. For example, in Franki piles, the bottom portion of a steel casing having 2-3 feet in diameter may be filled with a material in addition to a steel cylinder that has a diameter that is slightly smaller than the steel casing. The steel casing may be vertically positioned at the planned location and the drop weight is repeatedly dropped inside such that the encapsulation material inside the casing may be pushed to the desired depth with repeated blows of the drop weight. Once the casing is positioned at the desired depth, additional weight drops may be used to eject the material out of the bottom of the casing until a resistance to further displacement has been established. The prior art of the Franki pile method is used in the industry for the construction of piling for deep foundations, in this invention, the drop weight would be used in a novel method to push encapsulation material out of the casing and into the GWB construction area.

The spacing of the displacement columns will be based on several engineering factors, including but not limited to the required thickness of the VGB, the depth of the CCR pile, the diameter of the displacement pile, moisture content of the encapsulation zone, along with possible other considerations. The spacing and size of the displacement piles filled with encapsulation materials may vary for engineering reasons in different areas of the site.

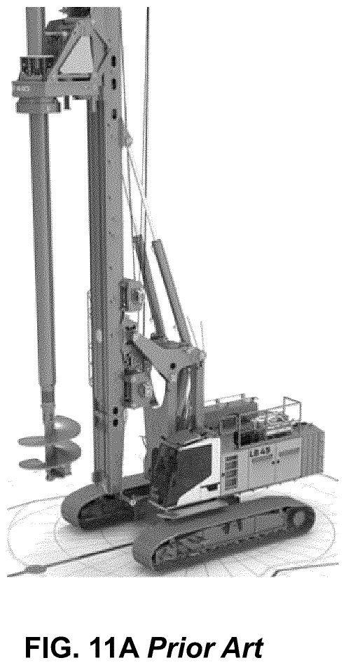

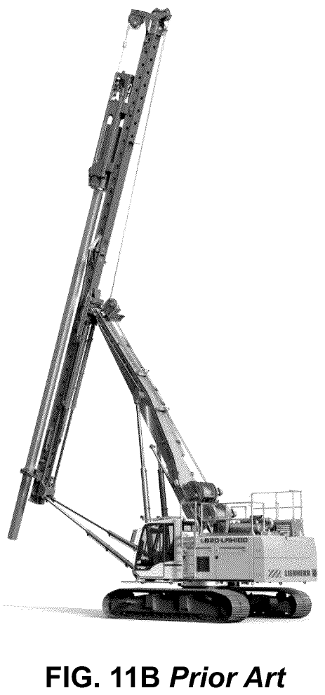

Another embodiment of the invention is to utilize a piece of equipment, such as that depicted by FIG. 11A, with a hollow-core stem and an auger and place encapsulation material directly into the VGB encapsulation zone in lieu of and/or in addition to using a displacement pile or any other embodiment process disclosed herein. Calcined gypsum, anhydrous gypsum, silicates, super absorbent polymers and/or other water absorbing materials can be placed in the encapsulation zones to absorb moisture, prior to the encapsulation and binding process. The encapsulation material in these hollow-core stems can be forced out by several different methods, including pressurized air, vibratory, hydraulic pressing, other kinetic forces, or a combination of these options.

Another embodiment of the invention is the use of a hollow stem auger, vertical or on an incline, used to place additional encapsulation at the lower below grade elevations during the encapsulation mixing process with pressurized air and binding agent(s). FIG. 11B depicts a type of inclined encapsulation material delivery system which could be employed, simultaneously with the equipment shown in FIG. 11A.

Another embodiment of the invention is to use CFA Continuous flight auger piles in a similar fashion as the procedure of using the displacement piles above. The CFA will be filled with encapsulation material or other material to be deposited in lieu of concrete and reinforcing steel (though concrete may be included in the encapsulation material).

Another embodiment of the invention is the use of a partial displacement pile in lieu of a full displacement pile as described in detail above.

Another embodiment of the invention is the use of auger cast piling equipment.

Another embodiment of the invention is the use of cased continuous flight auger drilling (CCFA) and/or CFA equipment.

Another embodiment of the invention is the use a Franki Piling system to place encapsulation material in the groundwater barrier area.

Another embodiment of the invention is to lower a mixing head next to one or more piles filled with encapsulation materials or other materials to be deposited rather than through the pile. Then the mixing head can be employed to disturb the piles and release the encapsulation materials into its area of effect once the discrete level to be mixed has been reached. Encapsulation materials in this application can be microbes as part of the MICP encapsulation process and the nutrients which cause the precipitation in the MICP process can be subsequently added using known types of prior art mixing heads. Since the nutrients for microbes will be applied in a liquid state, they can be added using know equipment in a novel application. This application is particularly applicable when full depth encapsulation is required. This application can also be used when a specified GWB depth is at the floor of a CCR pond for the specified thickness of the engineering measures.

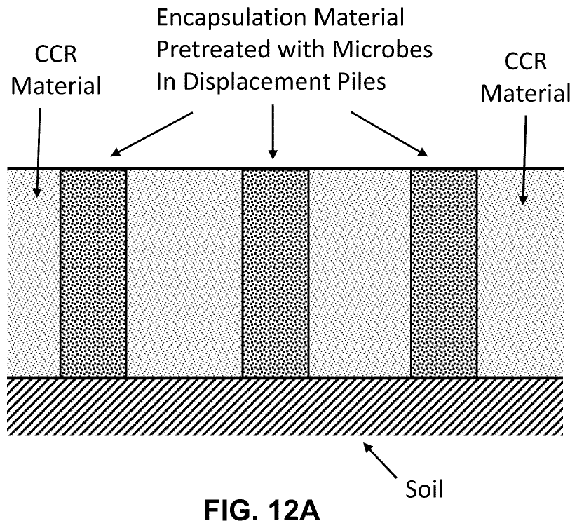

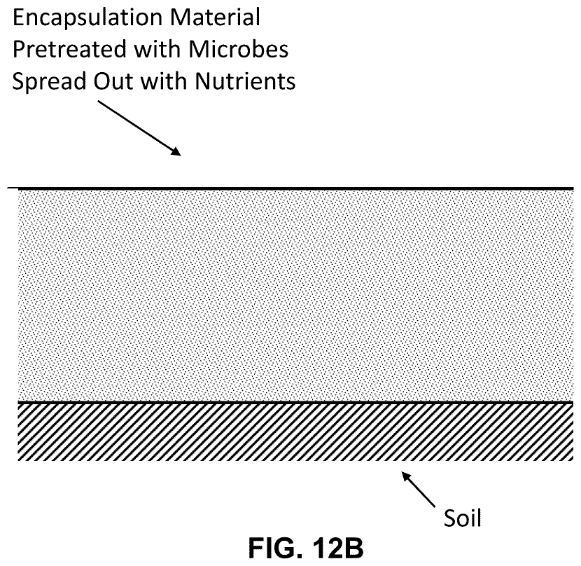

FIG. 12A depicts the encapsulation material pretreated with microbes and placed in displacement piles surrounded by CCR prior to the start of the mixing using the rotating mixing attachment and the addition of pressurized air and binding agent (if any) using equipment as shown for example in FIG. 11A. Depending on the type of existing materials below grade which will be mix with the encapsulation material formulation, pressurized air will not always be required to be utilized. As shown in FIG. 12B, in some applications, nutrients may be placed before mixing later with the microbes.

Another embodiment of the invention is to fill multiple piles in close proximity with encapsulation material and/or binding agent(s) such that a mixing head, with or without ports for the introduction of pressurized air and/or additional material nutrients for microbes, microbes mixed with nutrients can be used to draw material(s) out of multiple piles at once for mixing. Enzymes can be used in some geological conditions versus microbes in the MICP process. EICP can use the same methods for MICP as described in this application.

Another embodiment of the invention is the use of a steel pipe pile, modified with a sacrificial plate or hinged bottom like the displacement piles, that is installed and removed by a vibratory hammer, water jetting, or a combination of the two. These are options in addition to rotary drilling.

For some embodiments, quality and thorough mixing of the binder and encapsulation material is of upmost importance to make sure the VGB will meet its required use.

This application has many novel methods and processes to deliver encapsulation materials to the encapsulation zones, but without the proper and thorough mixing of these materials with the binding agent(s), some of these novel methods and processes would not be of any use.

Numerous machines and attachments are available in the industry for known encapsulation and soil mixing applications which may be capable of mixing the binding agent(s) and encapsulation material in-situ, or spreading other VGB forming materials. The known machine attachments are limited in their ability to deliver large amounts of solids to the GWB construction zones.

Another embodiment of the invention is the custom design of equipment as presented below with such specification, configuration, and type of mixing equipment with specific attachments and layout to guarantee proper application of the encapsulation and mixing materials.

Many CCR storage areas are ponds filled with water. The processes described herein may be utilized as being on barge mounted equipment. These barges can be site assembled using Poseidon barges or similar types. Spud barges may be employed as required.

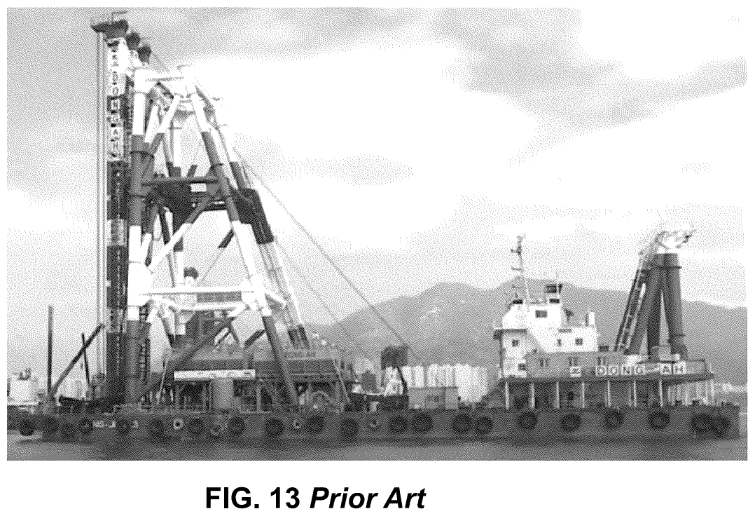

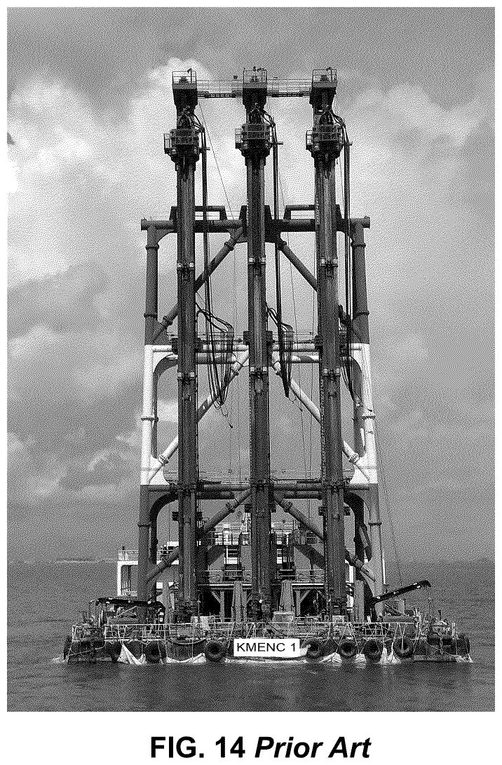

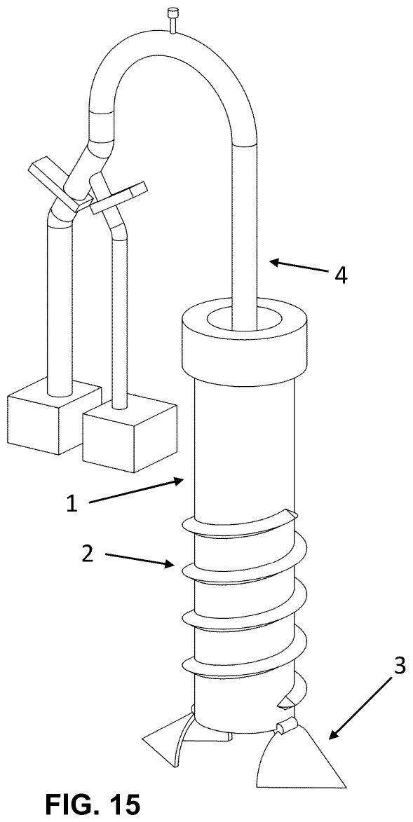

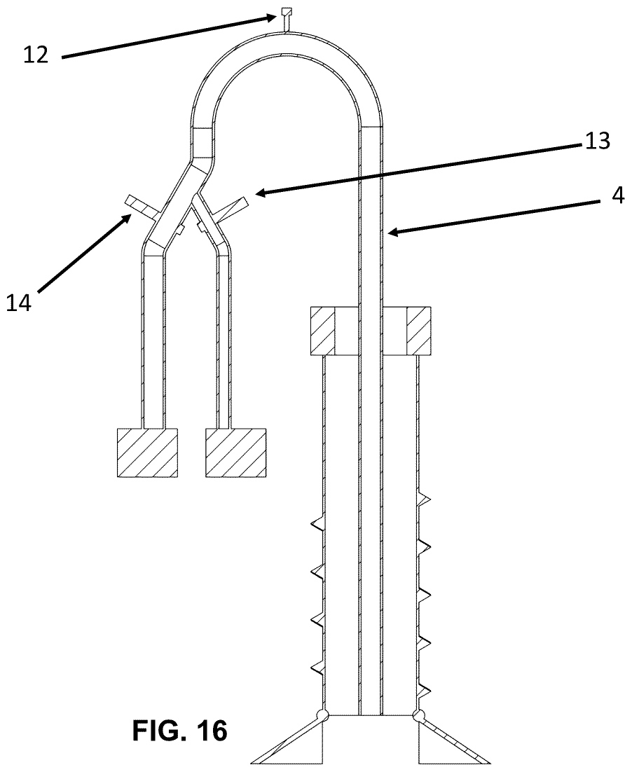

Another embodiment of this invention is to perform the methods and processes disclosed herein using barging and related tugs and equipment. The Hong Kong airport used deep sea soil mixing for the soil improvement of the additional airport runway with the equipment being mounted on barges. Custom designed and fabricated, barge mounted mixing equipment was used as depicted by FIGS. 13 and 14.

In addition to the processes and methods as described in this application being novel, custom equipment is presented in this application as novel inventions, as well.

There are many possible designs and configurations for site specific equipment and configurations for the encapsulation and binding process.

The processes and methods described in this application are not limited to application for the VGB for the floor for CCR ponds or other waste sites and they can be used in several different locations such as the vertical walls for the construction of an HGB.

The novel processes and methods described in this application can be done in a single stage or multiple step approach.

The processes and methods described in the invention of this application allow for increased speed of construction of encapsulation zones, as compared to other known types of in-situ encapsulation methods. This increased speed will reduce construction time and cost.

In-situ encapsulation by jet grouting, horizontal sealing slabs and other known means and methods are much different than the novel delivery and processes in this application which efficiently and relatively quickly place substantial amounts of materials below grade. One use of such a novel method of placing materials below grade is in the construction of a groundwater barrier (GWB). Novel apparatuses are presented in this application. Their use is necessary to achieve the construction of the GWB in an economical and timely fashion.

Coal Combustion Residuals (CCR) ponds can have greater than 45 percent or higher water content at the GWB level, and, in some circumstances, most of the water must be displaced by solid materials for the construction of the GWB. Absorbative materials or products can be also be placed in the prefilling and/or construction process.

Embodiments of this invention cause displacement of most of the high-moisture content in-situ material at the GWB construction location with different formulation(s) and application(s) of different types of materials and delivery methods. One example of this is the use of FGD to be placed with bottom ash, fly ash or a mixture of all these materials at the groundwater barrier construction area.

Other embodiments of this invention require certain formulated material to be placed at the GWB construction level to help with the MICP encapsulation process.

A GWB for CCR ponds should consider the barrier's 1) Hydraulic Conductivity, 2) its leachability and 3) its ability to stop the migration of water (Infiltration) either into or out of the CCR pond.

Additional items to consider before determining the best method, novel apparatus type, and formulation and application of materials to be used in the construction of the groundwater barrier include, but are not necessarily limited to:
1. The structural stability of the CCR pond
2. The moisture content of the CCR pond at different levels
3. The moisture level of the CCR at the location of the GWB
4. Can the CCR pond take vibratory energy being introduced into it without causing structural instability to the pond
5. The in-situ depth of the GWB construction location
6. The composition of the in-situ material at the GWB construction location
7. The bearing capacity of the CCR at the ground level to be able to support construction equipment
8. The time allowed for construction of the GWB
9. Whether the CCR pond can take impact energy being introduced into the CCR pond without causing instability to the pond
10. Whether the CCR pond has different layers of materials (bottom ash, fly ash, FGD, dirt, etc.) with different moisture contents located at different levels of the CCR pond
11. The sequencing of the construction methods
12. Whether an additional top coating such as asphalt or MICP is placed on the bottom layer as a composite for the GWB
13. The unconfined compressive strength of the in-situ materials at the groundwater GWB level.
14 The unconfined compressive strength of the below grade in-situ materials the apparatuses must travel through to reach the GWB level
15. Whether the installation being placed by rotary drilling
16. Whether the casing installation being placed by double rotary drilling
17. Whether the casing installation being placed by vibration
18. Whether the casing installation being placed by impact
19. Whether the casing installation being placed by hydraulic pressing
20. Whether the casing installation being assisted by air
21. Whether the casing installation being assisted by water jetting
22. Whether the casing installation being placed by a combination of the above
23. Whether the pre-drilling required before any of the above installation methods
24. The different energy required (Blow Counts) required to drive a piling through one foot of CCR at different levels.

With several different variables to consider in the determination of which material(s) and formulations are to be used for the construction of the GWB and which type of novel apparatus is to be used in the construction of the GWB, there are some, but not all, embodiments of this invention described in detail below.

The drawings (FIGS) shown in this application are not drawn to scale, and the height and width are drawn to a different scale in relationship to each other. The height of the equipment presented in this invention can be more than one hundred feet tall in certain applications, and the width of many of the embodiments presented can vary, but they will vary from approximately 3 feet to over 20 feet wide. Embodiments described below and referencing the drawings are not necessarily ordered in any rank of emphasis.

### Embodiment 1: Pressurized Air

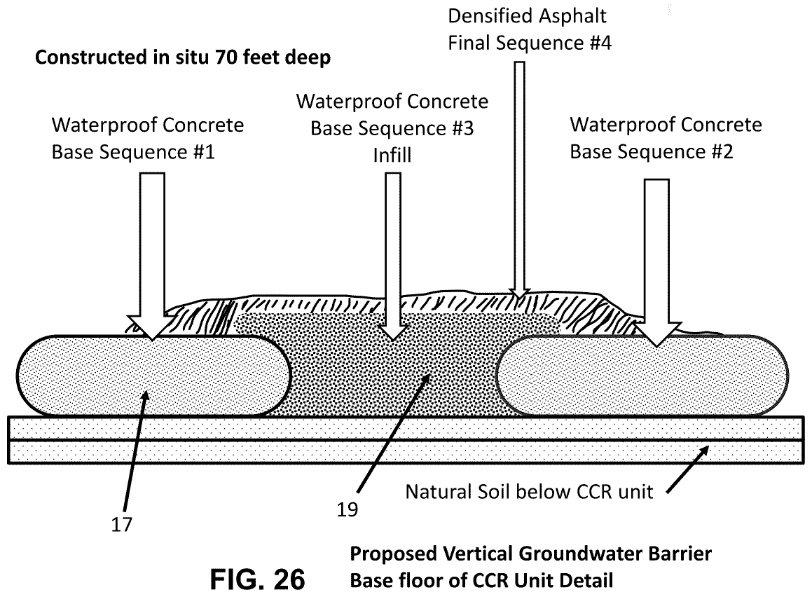

One embodiment is shown in FIG. 15. This embodiment is designed to be used when the in-situ GWB level has a low moisture content and higher unconfined compressive strength of CCR with high moisture content, and for infill sections as shown on FIG. 26, sequence three 19. Referencing FIG. 15, the outer metal casing 1 has spirals 2, and a hinged bottom 3 that opens when material is forced through the piping conveyance feature 4 (piping, tube, etc.). FIGS. 10A and 10B show two different types of hinged bottoms 3. Hinged bottoms that are flat and have a single hinge on one side of the casing can also be used. The casing shown in FIG. 15 is placed by rotary drilling using specialty deep foundation equipment produced by Liebherr, Fundex, Bauer, CZM and/or others. Other methods of installation using vibratory, impact, combination of different types, etc. of installation can also be used to place the casing 1 at the desired location and elevation for the construction of the GWB. The spiral curves 2 on the outside of the casing help move the casing down to its desired elevation during the rotary drilling process, and upwards during the extraction process. The casing is used as a mechanism to get the piping 4 to the desired location, and to protect the piping 4 during the construction process. Neither the casing 1 nor piping 4 remains in place but is continuously reused in the GWB construction process, though a sacrificial shoe could replace the hinged bottom 3. The sacrificial shoe is used as a capping element during insertion would remain in place. FIG. 16 shows a cross section cut of FIG. 15. The piping 4 inside the casing 1 in FIG. 16 is used to pump and place waterproof concrete (or other types of materials) at the GWB level, in-situ.

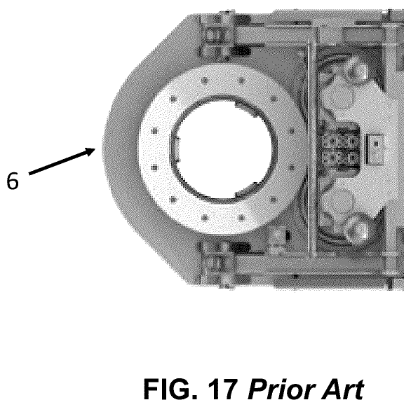

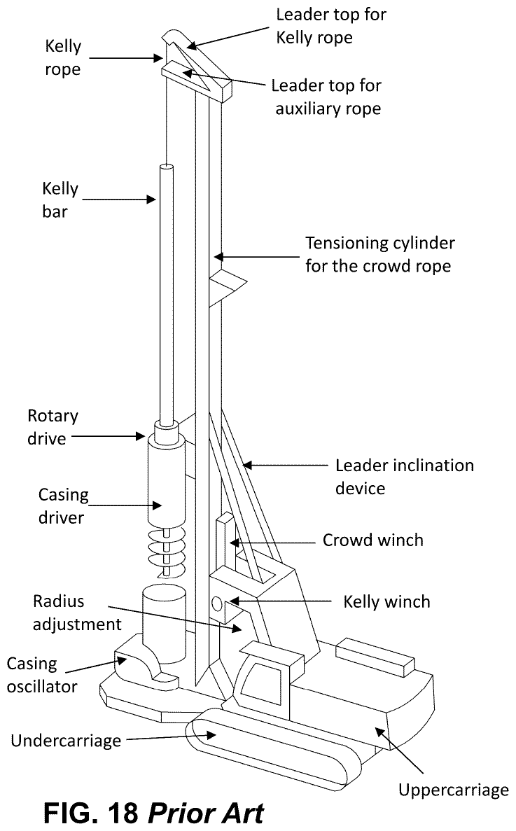

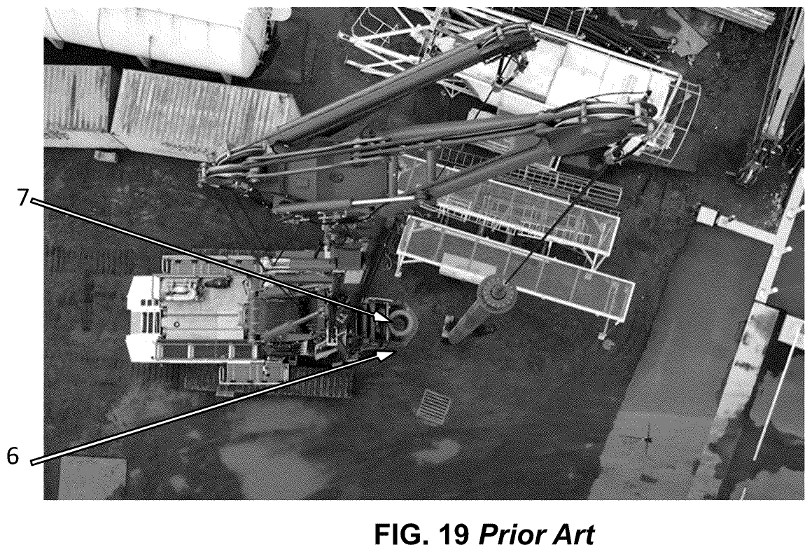

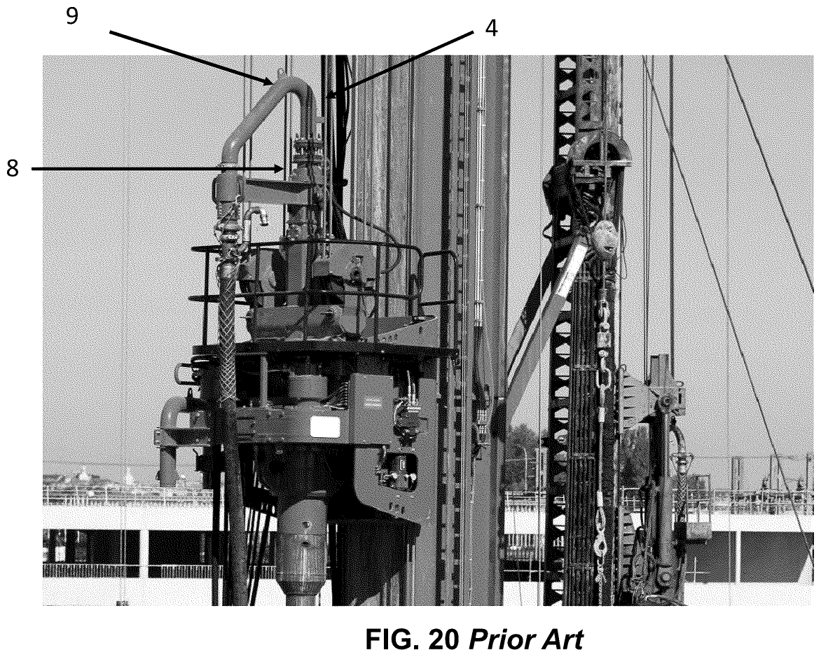

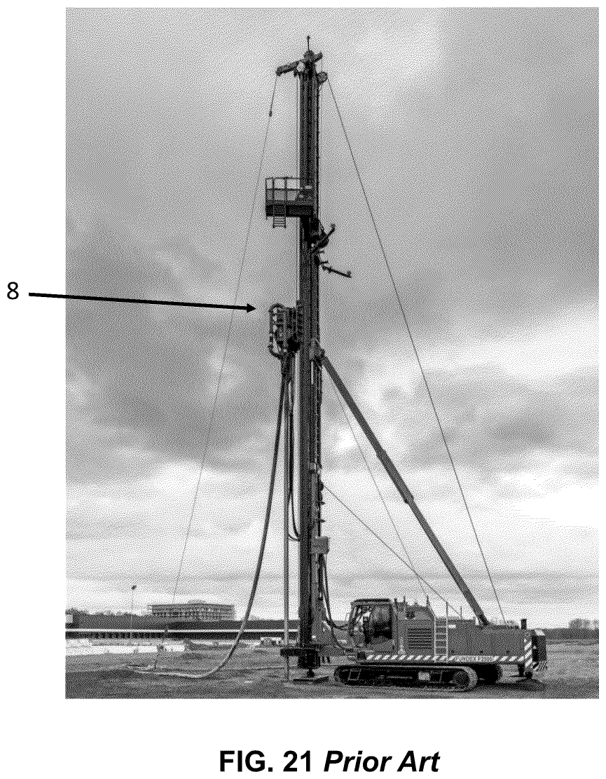

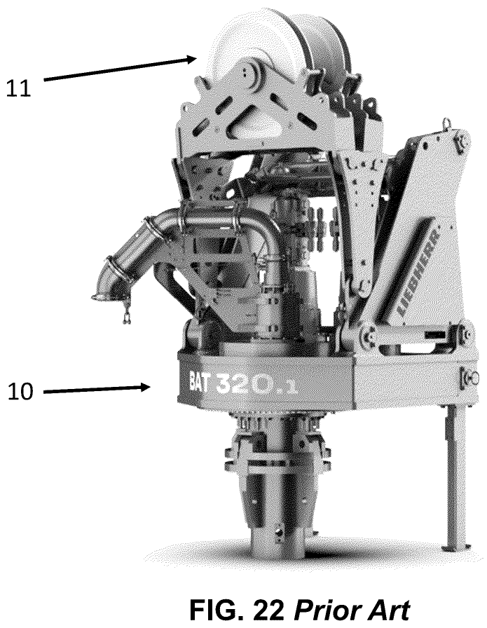

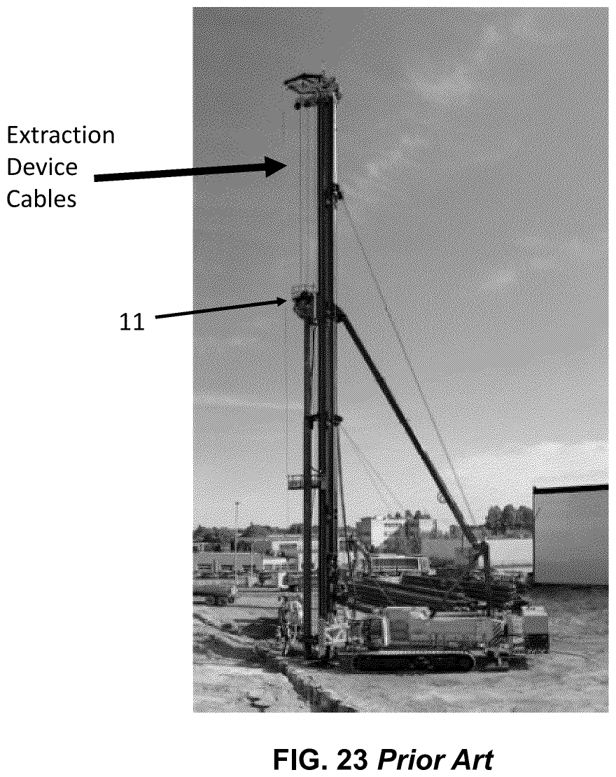

The casing 1 in FIG. 15 will be rotary drilled to the desired elevation using a single rotary drive 6 as shown in FIG. 17. The rotary drive 6 is located on a piece of deep foundation equipment as depicted in FIG. 18. FIG. 19 shows the rotary drive 6 that has a casing that will have an open top 7 to allow for the concrete pipe 4 to be placed down through the casing 1. A concrete swivel 8 as shown in FIG. 20 can be used to allow for the pipe to rotate inside the casing and to be supported by the casing, and at the same time allow for the gooseneck 9 of the concrete pipe 4 to stay stationary, hence one side of the pipe 4 connected to the swivel will rotate while the other side of the pipe 4 will not rotate. The concrete delivery system will be a closed system as shown in FIG. 20 and FIG. 21 to allow for the pressure needed to pump the concrete into the in-situ elevation. A horizontal cross-sectional plate or rotary swivel can connect the casing to the concrete swivel 8 or the concrete pipe 4 above or below the swivel to provide a seal to ensure that the pressure provided by the concrete pump carries the concrete into the soil/CCR without pushing it up the open top casing 1. FIG. 22 shows a closed concrete swivel system and a rotary head 10 with an extraction device 11 which will place an upward pressure on the casing when it is being extracted from the below grade in-situ material of the CCR pond after the concrete placement is completed. It is not shown in FIG. 22, but the extraction device will have cables which will apply upward force upon the extraction device. FIG. 23 shows a different type of extraction device 11, with cables that travel down the front and the back of the mast of the deep foundation equipment to hydraulic winches which create the extraction force when the casing is being extracted out of the below grade in-situ material.

The stationary side of the concrete pipe 4 that will be located above the rotary drive 6 will have a number of operable valves that can be operated by many different forms of energy including but not limited to pneumatics, hydraulics, or electrical magnetic solenoids. Referring to FIG. 16, one of the operable valves 12 is an air release valve, the second operable valve 13 is to control the introduction of compressed air into the concrete pipe and the third valve 14 is to shut off the pathway for the concrete that was pumped into the gooseneck of the concrete piping 4 from the concrete pump located on the ground surface which is not shown in this FIG. 16. This third valve 14 may not be required depending on the type of concrete pumping equipment that is used, and if the concrete pumping equipment can withstand the back pressure of the pressurized air pushing the concrete out of the concrete pipe 4 at the below grade in-situ GWB elevation.

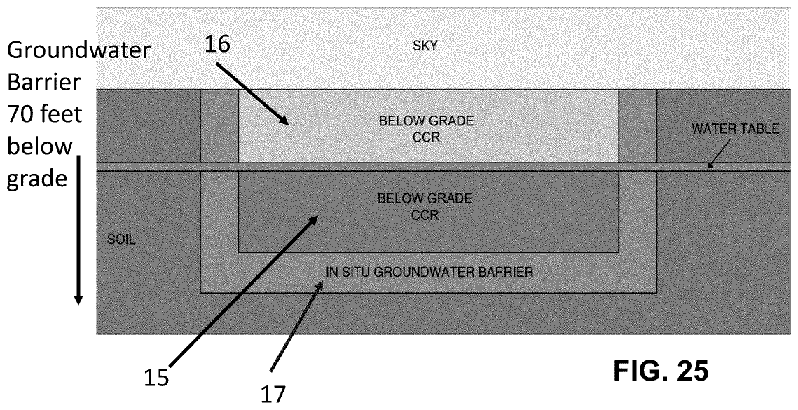

The operational sequencing of the valves is such that when the concrete has been pumped to the GWB below grade in-situ elevation, there may be concrete remaining in the convenance pipe 4. To expel the concrete completely out of the convenance pipe 4, air pressure will be applied whereas concrete will be pushed out to the GWB elevation 17 in FIG. 25. This serves the purpose of not wasting concrete that will by gravity fallout of the conveyance piping 4 as the casing 1 is being extracted out of the in-situ CCR material, and to not allow concrete to be deposited in the below grade material between the drilling equipment on the ground's surface and the top of the groundwater barrier 17 in FIG. 25. An additional operable valve may also be placed near the bottom of the conveyance pipe 4 to limit concrete waste during extraction.

The operable valves 12, 13, and 14 shown in FIG. 16 may be designed for one combined location for each of these operable valves, or multiple separate distinct locations. The operable valves, the air release valve 12 in particular, may be manually or automatically operated. There may also be a safety blowout valve/seal similar to the blowout valve on a pressure cooker.

FIG. 25 shows graphically a cross section cut of a CCR impoundment with different moisture contents for the below grade CCR. The lower section 15 can have a moisture content of more than 45% moisture, while the higher section 16 can have a moisture content lower than 27%.

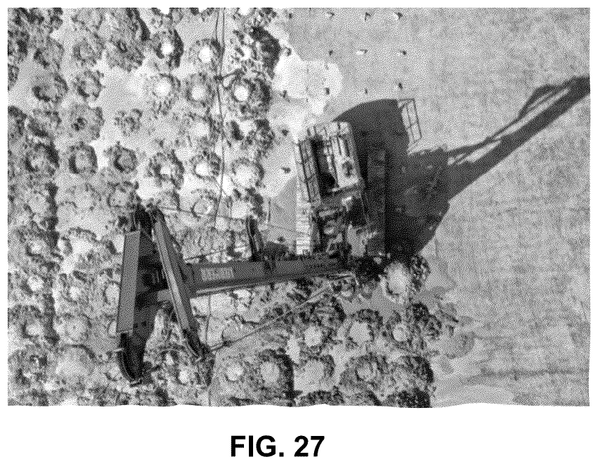

The GWB 17 constructed in-situ in FIG. 25 is shown in detail on FIG. 26. FIG. 26 details one of many different GWBs engineering design and construction sequencing which can be constructed. FIG. 26 shows a topping of asphalt 18 on top of the waterproof concrete, but many different types of sealers or water barrier types of materials and systems could be used. Not all engineering measures will have a composite two layered system. The infill section 19 is placed between other sections of the GWB which has already been placed to its east, west, north and south. Some construction designs could use no sealers on top of or below the waterproof concrete. FIG. 27 depicts the above-grade aerial view of the sequence of placing the GWB prior to the infill sections 19 being placed.

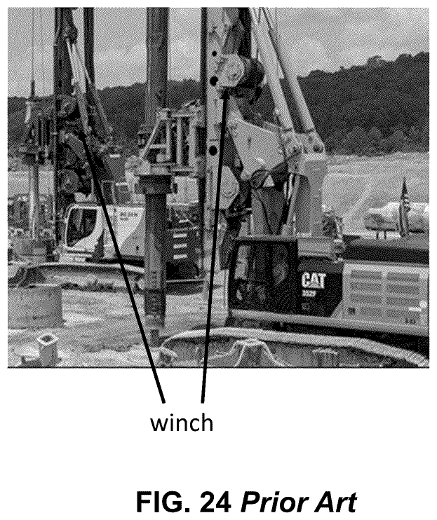

To summarize the sequence and process of constructing the GWB in this invention in this embodiment 1, the process is as follows:
1. A casing 1 will be drilled down by rotary deep foundation equipment to the below grade in-situ elevation. FIG. 25 shows an example in-situ elevation of minus 70 feet from ground level for the groundwater barrier 17.
2. Once the bottom of the groundwater barrier construction elevation is reached with the hinged bottom 3 of the casing 1, the rotary drive 6 will rotate upwards as concrete starts to be pumped. The valve 12 will be closed, the valve 13 will be closed, and valve 14 will be open as the concrete is pumped down piping 4.
3. A groundwater barrier material, waterproof concrete for example, will be pumped via the interior piping 4 to the groundwater barrier elevation.
4 When the proper amount of concrete has been pumped to the groundwater barrier elevation 17 of FIG. 25, pumping of the concrete will stop and pressurized air at a pre-determined pressure and volume will be used to eject the remaining concrete out of the vertical pipe 4 whereas it is placed at the GWB 17 construction elevation. The amount of air to be allowed into pipe 4 will also be predetermined whereas the air will not displace the concrete that has already been placed for the GWB 17.
5. The air release valve is to be opened once the concrete is pushed out of the piping 4, and immediately prior to extraction of the casing 1. Extraction is done by rotating the casing 1 in the opposite direction as the installation rotary direction (clockwise versus counterclockwise), while at the same time force is applied with the extraction device 11 of FIG. 22 which has cables connected to the extraction device and winches (FIG. 24) on the back of the deep foundation equipment's mast shown on FIG. 23.
6. The casing 1 will be completely retracted out of the CCR pond, such that the hinged bottom 3 as shown on FIG. 15 will be above grade.
7. The deep foundation equipment FIG. 19 will be relocated to the next rotary drilling location. The modern-day deep foundation equipment has a computerized GPS system whereas the location of the next drilling location is shown on a computer monitor inside of the deep foundation drilling equipment.
8. Relocate the casing 1 to new a location and repeat the process.

A suction/vacuum pump may be used to hold the concrete in the pipe 4 in place versus forcing the concrete out of the pipe 4 using pressurized air. A P-trap or similar design could be used in conjunction with the suction pump method. An open-closed valve (knife valve or other types) could be placed near the bottom of the pipe 4 which is hydraulically or pneumatically operated which will retain the concrete in the pipe 4 for the next rotary drilling location.

The embodiments described in these specifications can be used in conjunction with one or more of the other embodiments described in this invention.

Pressurized air is used in known deep foundation work for Down the Hole Drilling, and Reverse Circulation Drilling. Both means and methods are completely different than the novel use of pressurized air in this invention. The pressurized air in these methods is used to remove drillings or drill cuttings from below grade to the ground surface.

Displacement piles are used to make concrete piling to support foundations and/or structures. In this invention, displacement pile/casing are not used to make a foundation pile but are used as a means and methods to place materials at a horizontal layer, such as at the GWB elevation as described herein. Vertical GWB can also be constructed using this embodiment,

Vibroflotation is a method that uses vibratory energy to place and compact large amounts of solids to form a vertical stone column used to construct structural foundation systems. This method is entirely different and is used for a different application as compared to the inventions described in this invention's written specifications. When full depth MICP encapsulation is used, a vibratory probe, which is different than vibroflotation, may be used for compaction of the CCR which has been undergone the MICP process.

### Embodiment 2: Core Barrel Type Metal Forms

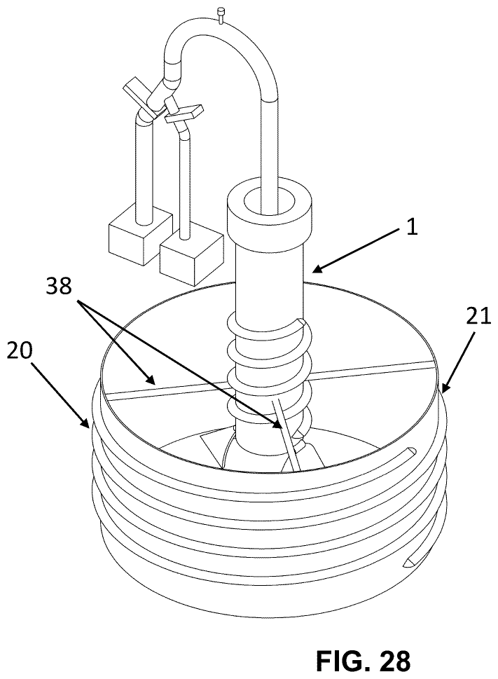

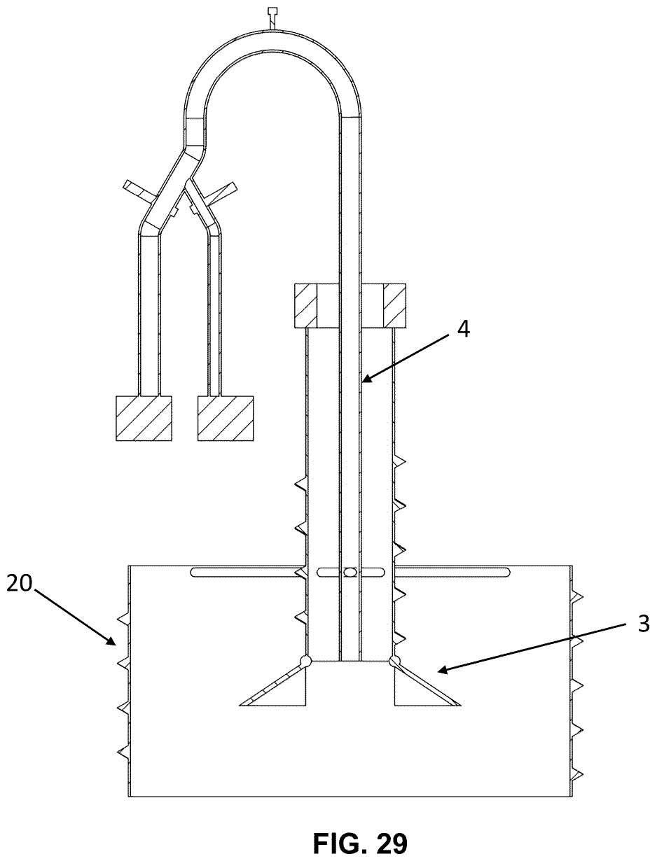

To more precisely place the GWB construction material as shown in detail on FIG. 26, core barrel metal forms can be used. FIG. 28 shows a core barrel metal form 20 which is attached to casing 1. The core barrel metal form will be connected to the casing by a metal framework of members 38. The core barrel metal form can have spirals 21 which will help with the rotating drilling downward during the construction process and the rotating upward during the extraction process. FIG. 29 shows a section cut of the equipment of FIG. 28.

Core barrels are used in traditional deep foundation work to drill soils or rock which have a high compressive strength and/or hardness. This invention uses the core barrel type formwork in a different application in that they are used to help in the precise placement of GWB construction materials. The concrete envisioned to be used is a low slump heavy weight concrete that displaces the CCR at the GWB elevation. Using the core barrel form, it allows the concrete to be placed in the proper location. The use of core barrel forms are envisioned to be used in GWB sequences 17 as shown on FIG. 26. Core barrel metal forms 20 can be solid material around its entire circumference as shown in FIG. 28, or they can have openings in designed locations to let the high-moisture content CCR outflow from the interior of the core barrel as the denser concrete material is pumped into the center of the core barrel form through the hinged bottom 3.

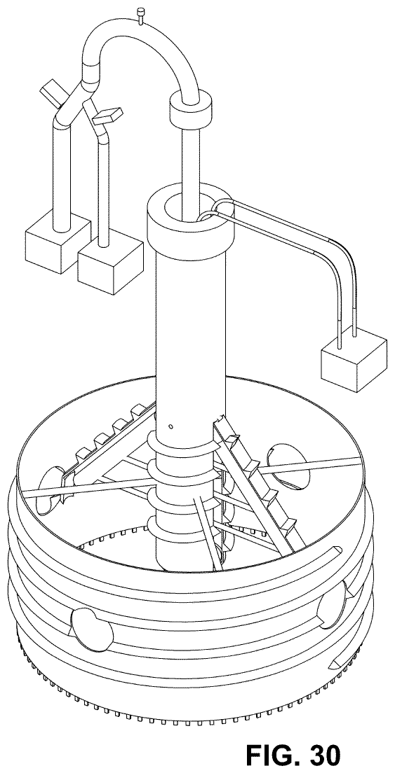

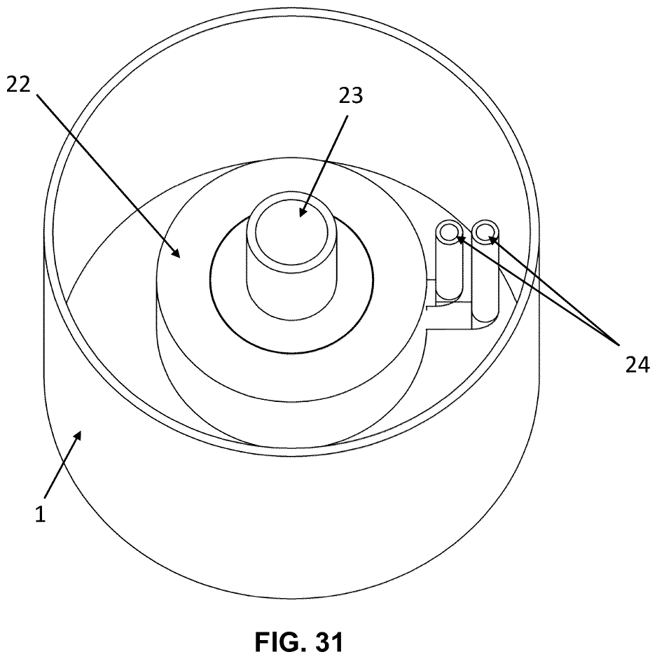

FIG. 30 shows a non-limiting example of openings that could be designed in the core barrel type metal forms. The height and diameter of these core barrel type forms can be of many different heights and diameters. The moisture content and the unconfined compressive strength of the CCR that the core barrel forms and casing must drill through will be one of the main determining factors of the size and shape of the forms. Encapsulation materials can be placed with other types of pumps, including progressive cavity pumps as manufactured by SEEPEX and others of similar function. The progressive cavity pumps, displacement pumps, and plunger pumps as used in fracking processes for oil and natural gas can also be used for pre-filling of areas with bottom ash, gypsum, sand, absorption products and other materials in the GWB construction areas. These same types of pumps can be used for the construction of the GWB.

### Embodiment 3: Rotary Unions, Swivels, Swing Joints, Tidal Lock Rotating

Concrete single-passage swivels are commonly used in the deep foundation industry for placement of concrete in displacement piles, auger-cast piles and other types of deep foundations. Prior art jet grouting and soil mixing also employ rotary equipment. The novel equipment design of using a single-passage rotary union for hydraulic oil, and/or the use of multi-passage rotary unions for concrete (and/or other types of materials including, but not limited to, other solids) and hydraulic oil allows for the equipment inventions presented in this specification. Microbes and nutrients for the MICP process can also be delivered through the multi-passage rotary unions. Rotary Unions for pressurized air can also be used in novel ways to assist forcing materials out of the casing 1.

A leading manufacturer of rotary unions, DSTI post on their website the explanation of what a rotary union is: “Also referred to as a rotary manifold,” swivel joint, rotating joint, rotary coupling, fluid swivel or fluid rotary union (FRU). Rotary unions are engineered for each unique application, taking into consideration media types, number of flow paths including single passage for one medium or multi-passage for multiple, simultaneous flows, temperatures, pressures, speeds, loads, and environments. A rotary union functions by connecting a stationary input (supply) to a rotating part, allowing a moving connection to be preserved and permitting the flow of media (liquids, solids and gases). Rotary unions are utilized in a wide range of industries, from compact rotary unions for semiconductor applications, to large and rugged-duty rotary unions for energy, defense and industrial applications.”

FIG. 31 shows a top view of a multi-passage rotary union 22, located inside the casing 1, that has a large center passage 23 for concrete, and two smaller openings 24 for hydraulic oil. Many different configurations and number of passage configurations can be used for all types of materials including liquids, solids and gases, or a combination thereof.

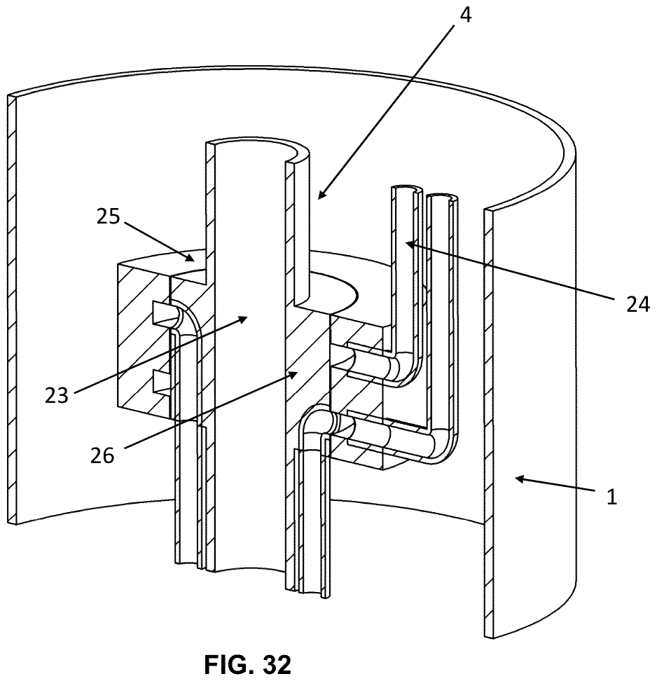

FIG. 32 shows a cross-section view of the apparatus FIG. 31. In FIG. 32, the stationary part of the rotary union 25 is the exterior piece, and the rotating piece 26 is the interior piece of the rotary union. Not shown in FIG. 32 is the concrete swivel for piping 4. Many different rotary union designs can be applicable to the inventions in this specification.

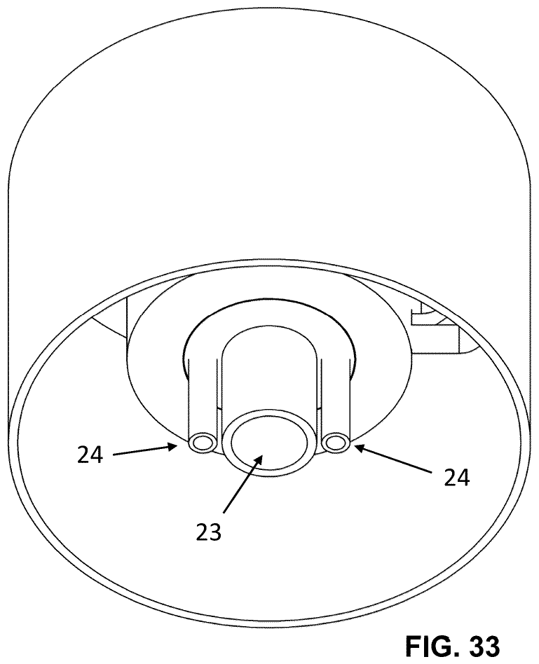

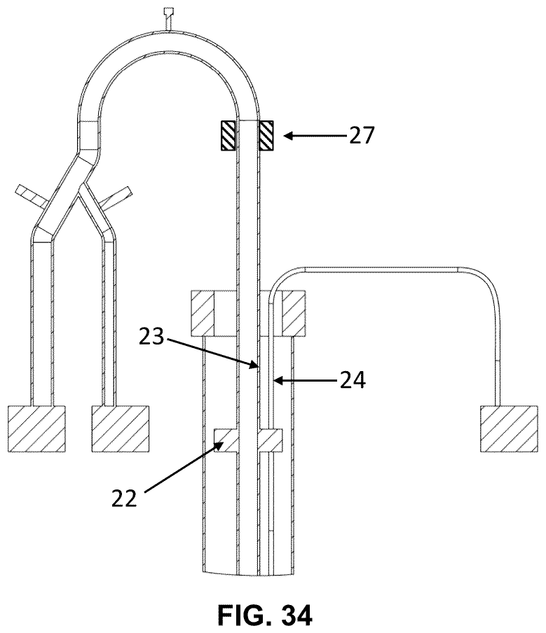

FIG. 33 shows a bottom view of the apparatus of FIG. 31 and FIG. 32. FIG. 34 depicts an invention presented in this specification which differs from that of FIGS. 31, 32 and 33. FIG. 34 depicts an invention with a rotary union 22 for hydraulic oil and concrete. A concrete swivel 27 is located above the rotary union. The rotary union 22 includes two smaller 24 passages for hydraulic oil, and one larger pass-thru passage for the concrete pipe 23.

Another method that can be applied for the different embodiments as detailed in this specification, is to use a single-passage rotary unions for solid fluid materials such as concrete and a rotary unions with multi-passage for hydraulic oil that are used in a tidal locking rotation which allows for synchronous rotation, rotating together without relative rotation therebetween. An industrial turntable, and/or swing joints may be used in conjunction with this application as necessary.

### Embodiment 4: Hydraulically Operated Chutes

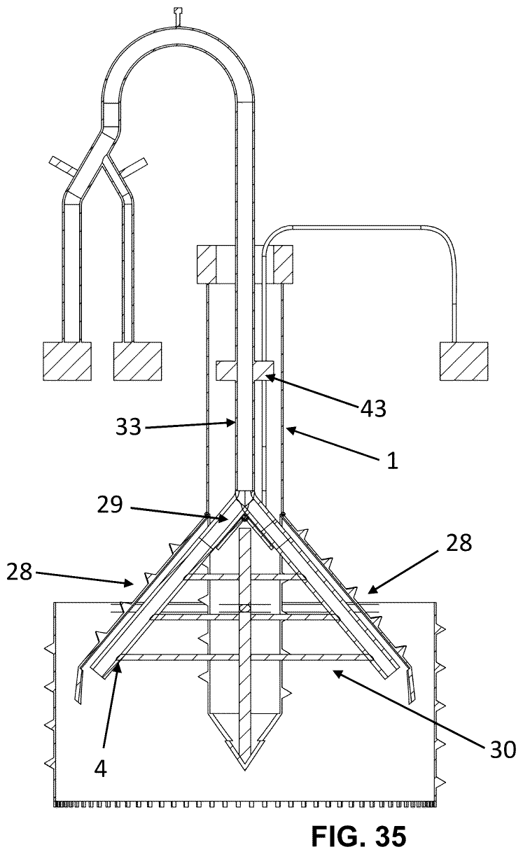

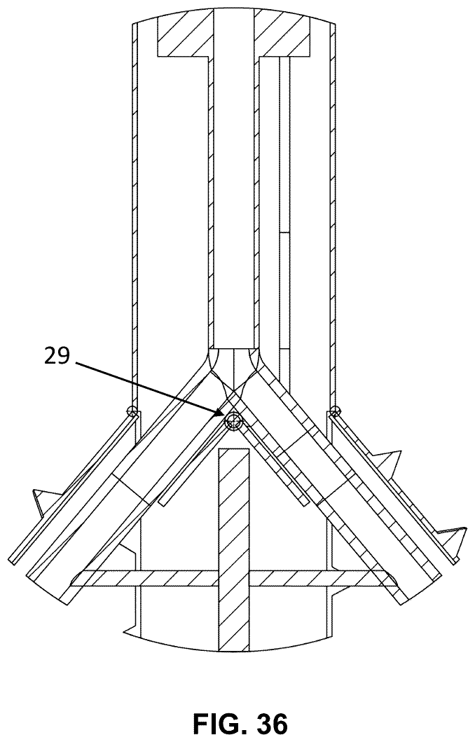

Another novel embodiment for encapsulating waste in-situ is shown in FIG. 35. This embodiment has hinged chutes 28 which are connected to concrete piping 33. The hinged chutes are attached to the casing 1. A multi-passage rotary union 43 is shown. Another option, not shown, is to use a single-passage concrete swivel and a separate rotary union for the hydraulic lines. When the apparatus shown in FIG. 35 reaches its desired elevation for GWB construction, hydraulics cylinders or hydraulic rotors 29 will be used to open and spread the hinged chutes 28 in a choreographed process in conjunction with the pumping of waterproofed concrete (or other types of GWB construction materials including MICP) to allow for the even distribution of concrete across the core barrel forms. FIG. 36 shows a detail of the hydraulic workings 29. These hydraulics can be Kinshofer, Hagglunds or others of similar function. FIG. 35 shows braces 30 that travel along rail guides as chutes 28 open and close. These braces 30 allow for structural stability of chutes 28 as they rotate with casing 1 to spread the concrete in a circular motion, and inward and outward fashion of the hinged chutes 28, to cover the entire area of the interior bottom of the core barrel forms.

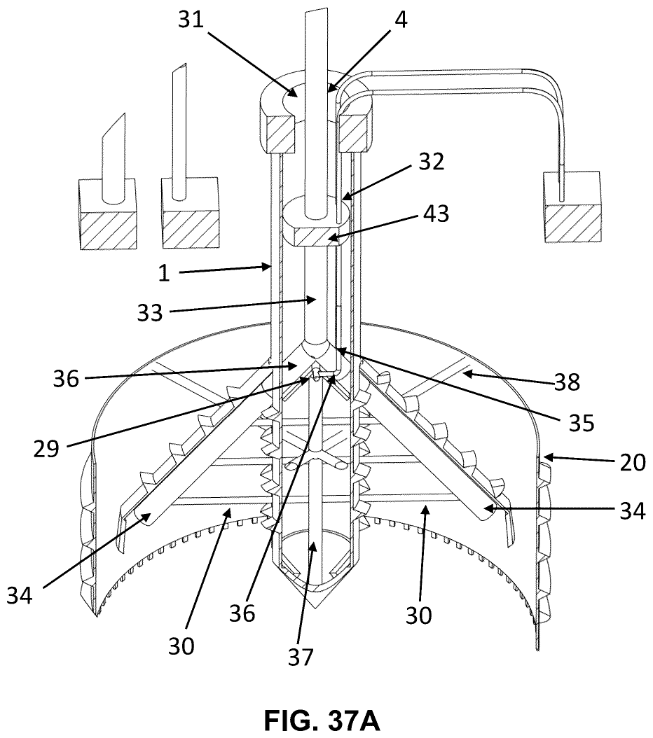

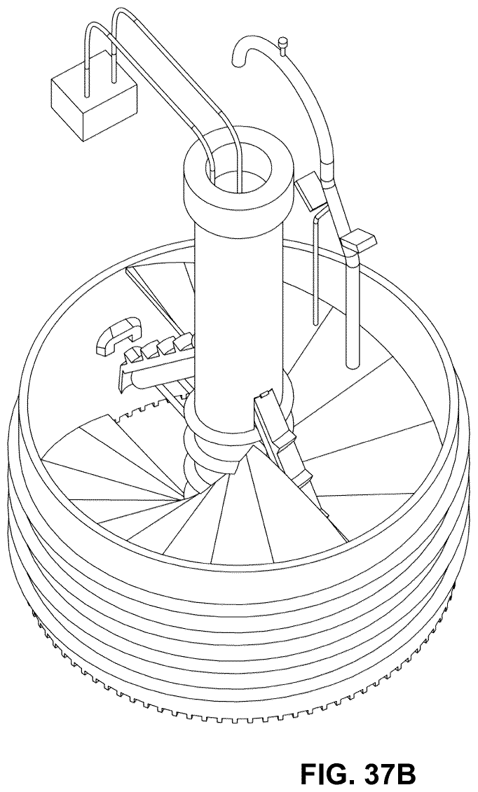

FIG. 37A shows the casing with an open top 31 with a non-spinning concrete pipe 4 going down the middle of the casing 1 which is connected to a multi-passage rotary union 43. The hydraulic lines 32 are also connected to the multi-passage rotary union. Once the concrete pipe and hydraulic lines pass through the rotary union 43, they can spin when the casing 1 is rotated by the rotary drive 6 which is shown FIGS. 17 and 18 and that is not shown in FIG. 37A. The concrete pipe which can spin 33 is connected to two separate flexible concrete pipes 34 which travel outward and subsequently inward by the force exerted by the hydraulic apparatus 29. The hydraulic pipes 35 which can spin after passing through the rotary union 43 when the casing 1 is rotated are also connected to the hydraulic apparatus 29. The multi-passage rotary union 43 in FIG. 37A is shown inside the casing, but some embodiments of this invention will have the rotary union above the top of the casing 31. The spinning concrete pipe splits into two pipes 34 that each connect a section of flexible concrete piping 36 to the pipe 33. The flexible sections of concrete piping can then transition back into solid piping 36 for the final sections of the concrete pipe. The final sections of the concrete pipe spin in unison with the casing. When pumping of the concrete commences, the chutes 28 and piping 34 will be slowly pushed out by the hydraulic rotators 29 while the casing 1 is rotated, which causes all the apparatus below the rotary union 43 to rotate in unison. This process of rotation of casing 1 and the slow planned outward progression of concrete pipes 34 allows for the denser weight of concrete to slowly push the lighter weight and less dense CCR up and out of the metal forms, while at the same time placing concrete to cover the entire area of the core barrel forms' interior bottom area. The equipment of FIG. 37A can also be used for placing prefilling materials in the GWB areas.

Structural member 37 in the middle of the casing and which is connected to the bottom of the casing along with the movable bracing 30 provide structural stability to the invention. The core barrel metal form 20 is an optional piece of equipment in this embodiment. The core barrel metal form, if selected to be used, is attached to the casing by structural members 38. Another option to attach the core barrel metal form to the casing is to have interior spiral ramps as shown on FIG. 37B. These interior ramps not only provide structural stability for the apparatus, it also helps in the drilling process for CCR that has a high unconfined compressive strength. This option may be useful when drilling through a top layer on a site that has CCR with low moisture content.

Some embodiments can be created with only one concrete pipe 34 and some embodiments could be designed with more than two concrete pipes 34.

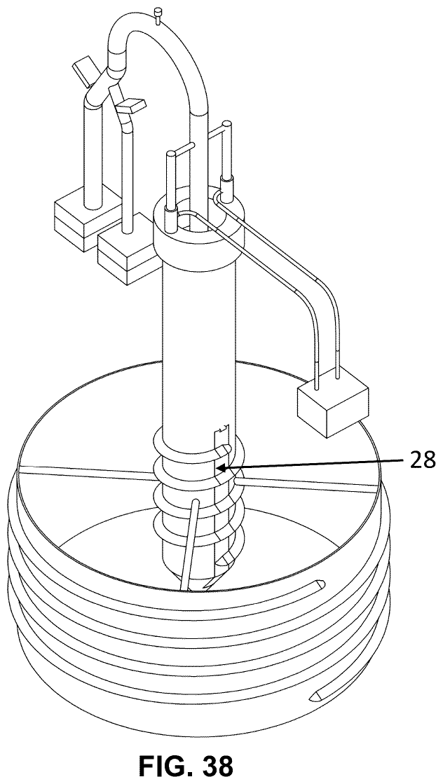

FIG. 38 shows this embodiment when the concrete chutes 28 are in the closed position, and the concrete pipes 34 are in the interior of the casing.

### Embodiment 5: Vertical Conveyor using Radial Piston Hydraulic Motor(s)

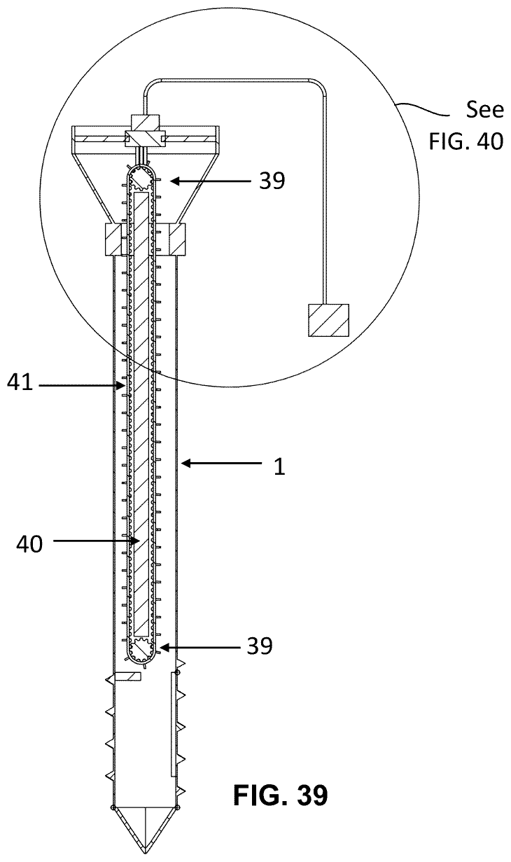

Another inventive embodiment is shown in FIG. 39. This embodiment of FIG. 39 includes one or more hydraulic radial motors 39, a steel plate 40 that bifurcates the casing 1, and CAT tracks and CAT Chain 41 with external track extension for moving material. Below the lower hydraulic motor, a plate will block the return path of the CAT tracks whereas only a small amount of in-situ material will be carried back to the top of the casing. The bottom of the casing can have a double or single hinged bottom. The Cat Track will have only a few inches of clearance from the outside of the casing to allow for more efficient forcing of the formulated material down to the GWB construction elevation. The projection flange on the CAT tracks can be designed to have a hinge whereas on the movement upwards after rotating around the sprocket powered by the bottom hydraulic motor, the flange will not carry in-situ materials upward.

This embodiment can be used to place material for construction of the GWB in high moisture content areas as to prep the area for the placement of microbes and nutrients for the MICP and/or EICP processes, or other types of materials required for the encapsulation of in-situ CCR and/or other types of waste.

The material can be ejected from the bottom of the casing by means of cycling pistons, rotating barrels, rotating wheels (with or without paddles) mounted in various configurations utilizing paddles, friction, or centrifugal force, and/or conveyor belts with or without CAT tracks of various sizes and driven passively, by gearing to the main CAT chain 41 and it's hydraulic motor(s) 39, or by additional hydraulic lines run through a rotary swivel (if required) and down the walls of the casing. Hinged bottoms, which are not shown in FIG. 39, can be used.

The casing shown in this embodiment, can be placed by hydraulic pressing, rotary drilling, vibratory or impact driving, amongst other types of know means and methods. The casing is shown to be circular, but other shapes such as rectangular or squares could be used in this embodiment.

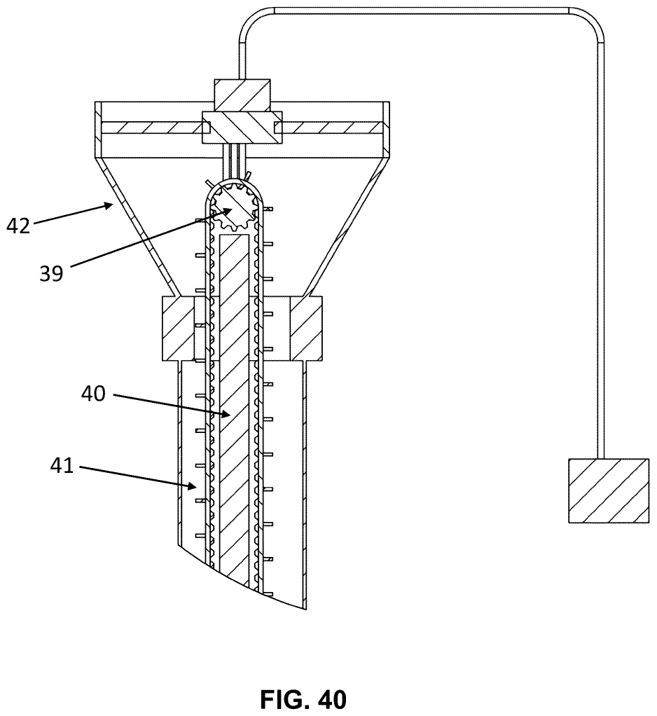

FIG. 40 is a detailed enlargement of the receiving supply container 42, the steel plate 40 that divides the casing into halves, and the hydraulic motor 39.

### Embodiment 6: No Rotary Union, No Spinning Hydraulics

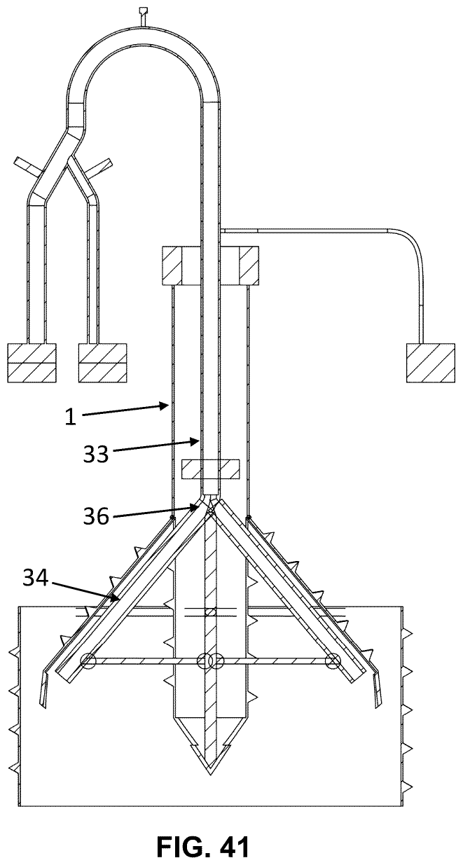

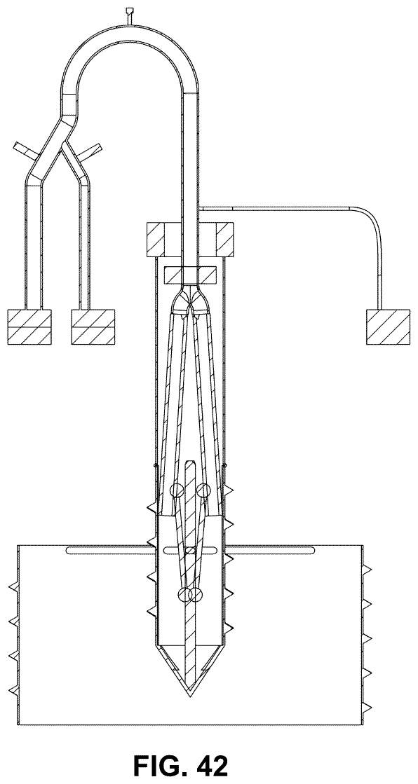

Another embodiment of the design is to spread the movable concrete piping 34 (FIG. 37) out of the doors by pushing the rigid inner concrete pipe 33 down relative to the casing 1. The relative downward force applied to the movable concrete pipes 36 can be directed outward by fixing the bottom ends of the movable piping 34 to telescoping rods that allow the end of the movable piping to go straight out only (FIG. 41). To retract the concrete outlets 34 and close the doors (FIG. 42), the inner concrete pipe 33 is lifted relative to the casing 1, pulling the simple concrete pipe swivel 27 of FIG. 34, replacing the hydraulic rotary union 43 (FIG. 37) and the top of each section of flexible piping 36 up, and thus pulling the bottom of each movable pipe 34 inward. In such an embodiment, the doors can be connected to the movable concrete pipes 34 by loose rungs that slide up and down the pipes.

The rigid inner concrete pipe 33 can be pushed down relative to the casing 1 by stationary hydraulic cylinders on top of the rotary drive 6 (FIG. 17), by an auxiliary rope as shown at the top of FIG. 18, or other means.

By having any hydraulics act only upon the non-rotating upper segment of concrete piping 4 (FIG. 37), the need for a rotary union capable of routing hydraulics 43 is removed. Only a simple concrete swivel 27 (FIG. 34) is required. Pushing the tops of the movable piping 36 (FIG. 37) downward as a mechanism of forcing the outlet pipes 34 outward also allows for the bottom outlets of the outlet pipes to maintain a horizontal plane as they extend and retract, without the need for telescoping movable concrete piping, in some instances.

This mechanical mechanism is in some ways similar to the operating mechanism of some prior art belling buckets; however, it serves a novel purpose and can be activated at any location without the need for a solid floor as the casing 1 provides the reference point of resistance to redirect the downward force of the concrete pipe 4 outward.

The non-spinning concrete pipe 4 can be supported by a passive turntable or similar above the swivel, and/or the spinning concrete pipe 33 can be supported by connecting rods or a plate of metal between the casing 1 and the spinning concrete pipe 33 and/or the swivel 27 (FIG. 34).

### Embodiment 7: Concrete Outlet Pipes are Rotated Horizontal Before Pumping of Material Out of Holes Along the Distance of the Outlet Pipes

Another embodiment of the design is to place the hydraulic rotators 29 of FIG. 37 near the bottom of the doors rather than the top and have them rotate the movable concrete outlet piping downward. By running the inner concrete pipe 33 down to the base of the outlet piping 34 and rotating the top of the outlet piping outward, horizontal outlet pipes can be achieved. The horizontal outlet pipes can have holes drilled along their length of the bottom or elsewhere which may increase in size as they move from the drill casing outward to compensate for decreasing pressure and achieve a near uniform dispersal of material along the bottom of the outlet pipes. The outlet pipes may be closed or partially closed at their ends.

The same can be done with embodiment 4 and rotating the outlets all the way up and horizontal before pushing concrete out of holes along the length.

### Embodiment 8: Multiple Separate Pathways for Placement of Multiple Materials or Mixtures Simultaneously

Another embodiment of the design includes two or more separate pathways down to the deposition zone. Such separate pathways may be helpful in depositing two or more materials or mixtures separately so as not to allow them to mix until they are being or have been deposited into the deposition zone. This may be advantageous for certain reactant solutions that should be kept from mixing until deposited into the deposition zone, for example. Such multiple separate paths could be achieved via segmenting the primary concrete pipe with a bisecting metal plate and pushing a separate mixture down either side, for example. Such a method could be achieved with one or more section dividers and two or more outlet pipes, one outlet for each separated section of the primary concrete pipe. Alternatively, multiple entirely separate concrete pipes (or similar pipes) could be used to provide multiple separate pathways. Such a system could use a rotary union system similar to that shown in FIGS. 31-33. One or more pipes could be combined with Embodiment 5 as one potential means of conveying both solids and one or more separate fluid mixtures down to the deposition zone at the same time.

### Embodiment 9: Heating and Cooling Elements

Some materials could benefit from heating or cooling elements being placed around the piping or conveyance methods within the invention's design. For example, tars and similar liquids may benefit from heating elements to lower their viscosity while certain reactants (like those used for MICP) may benefit from cooling elements to slow their initial reaction rate in both premixed and soon to be mixed variations of application. The heating and/or cooling elements could be powered within the casing and/or above grade by any available means, such as electric, gas, petroleum, etc.

### Embodiment 10: Geophysical Sensors-Electrical Sounding, Radar, Pressure Sensors, Chemical Sensors, etc.

Another embodiment of the design incorporates at least one electrode and or other sensors into the design. The presence of electrodes on the various designs discussed could be used for verifying the presence, location, integrity, etc. of the material deposited, as well as the moisture content of the deposition zone both before and after deposition, utilizing the concept of vertical electrical sounding as one example of many potential options. One potential application of this embodiment could be to put an electrode or other sensor near the tip of the casing and/or on the barrel core attachment. One or more additional electrodes or other sensors could be placed along the casing or elsewhere above the targeted deposition zone, theoretically even at grade in some applications. The basic operating principle of electrical sounding as an example is that the electrodes are brought to different voltages, and the resulting current is monitored to determine the resistivity of the material between them. The initial resistivity can be compared to known reference values of the resistivity of the medium awaiting deposition to determine an approximate moisture level. The resistivity can then be monitored while deposition occurs to ensure the depth, integrity, uniformity, etc. of the deposited layer. Different arrays of multiple electrodes and/or other sensors may help with clarity and understanding of the layer uniformity. Depending on the method of application, the electrical probes and/or other sensors can be used to check the condition of an area of varying size, thus the effect of an individual casing's deposition and the combined effect of multiple depositions can be monitored. It is possible to utilize one or more traditional vertical electrical sounding probes separately or in combination with the novel vertical electrical sounding methods disclosed herein, though the novel methods of utilizing integrated sensors disclosed do have some unique advantages by being on opposite sides of the region of deposition during such deposition. The region of any metal around the deposition zone being monitored could be covered in electrically insulative material or otherwise made less conductive of a pathway between the electrodes or otherwise treated to minimize interference with other sensors to increase the clarity of the zone being monitored as necessary.

Alternative electrical geophysical surveying methods such as induced capacitance and induced polarization (magnetic capacitance and hysteresis) can also be used independently or in combination with electrical resistivity measurements to analyze the deposition area and materials before, during, and after the deposition process. Ground penetrating radar can also be used both above grade and at depth integrated into the casing of the invention in such a way that constitutes a novel method and/or invention itself or not. Seismic pressure conductivity, reflection, and resonance can also be used to analyze the deposition zone and construction. Additionally, a chemical could be released at one location and detected at another, either as a component of the deposited material or elsewhere as a signaling chemical.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A method for constructing an encapsulation barrier, comprising:
positioning a tremie pipe over a surface of a substrate material at first pile point;
attaching a capping element to a lower end of the tremie pipe;
lowering the capping element and a portion of the tremie pipe into the substrate material at the first pile point;
applying an encapsulation material into an upper end of the tremie pipe until an upper surface of the encapsulation material reaches a particular level relative to the surface of the substrate material;
raising the tremie pipe while maintaining the upper surface of the encapsulation material at the particular level relative to the surface of the substrate material;
inserting a mixing tool into the tremie pipe, the mixing tool pushing the encapsulation mixture downward within the tremie pipe; and
applying an additional volume of encapsulation material into the tremie pipe to form an encapsulation barrier.

2. The method of claim 1, further comprising leaving the capping element within the substrate material below the encapsulation mixture while raising the tremie pipe.

3. The method of claim 2, wherein the capping element comprises one of a sacrificial shoe, a sacrificial plate, and a sacrificial drill tip.

4. The method of claim 1, wherein the capping element comprises a hinged bottom.

5. The method of claim 1, wherein lowering the capping element and a portion of the tremie pipe comprises rotating the tremie pipe.

6. The method of claim 5, wherein the tremie pipe comprises external threads.

7. The method of claim 1, wherein the substrate material comprises at least one of air, oil, and resins.

8. The method of claim 1, wherein the encapsulation material comprises at least one of coal combustion reside (CCR) and oil.

9. The method of claim 1, wherein the encapsulation material comprises cement.
